(19) United States
(12) Patent Application Publication
(10) Pub. No.: US 2026/0277936 A1
(43) Pub. Date: Sep. 17, 2026

(54) AI-BASED ATTRIBUTION OF ISSUES TO STAGES OF DATA PROCESSING PIPELINES

(71) Applicant: NVIDIA Corporation, Santa Clara, CA (US)

(72) Inventors: Abhinav BALASUBRAMANIAN, Milpitas, CA (US); Rama Kalyani Tirumala AKKIRAJU, Cupertino, CA (US); Anbang XU, San Jose, CA (US); Aaditya Ramshankar SHUKLA, Fremont, CA (US); Pritam Surehlal GUNDECHA, San Jose, CA (US); Sidney Anne KNOWLES, Campbell, CA (US); Lu AN, Queen Creek, AZ (US); Di XU, Mountain View, CA (US); Yang JIAO, Mountain View, CA (US); Tony Wijaya SALIM, Santa Clara, CA (US); Japinder SINGH, Union City, CA (US); Tan YU, San Jose, CA (US); Meghana PUVVADI, San Jose, CA (US); Ryan Richard ANGILLY, Denver, CO (US); Santiago POMBO, San Francisco, CA (US); Lei YANG, San Jose, CA (US); Deepak BORA, San Ramon, CA (US); Meenakshi MADUGULA, Newark, CA (US)

(21) Appl. No.: 19/077,944

(22) Filed: Mar. 12, 2025

(51) Int. Cl. G06F 16/28

(52) U.S. Cl. CPC G06F 16/287

(57) ABSTRACT

Embodiments of the present disclosure relate to AI-based attribution of issues to specific data processing pipeline stages. For instance, some embodiments detect and classify inefficiency issues, anomaly issues, or failure issues in a data processing pipeline, such as those used in conversational AI systems, search engines, or retrieval-augmented generation (RAG) frameworks. The system monitors various stages of the pipeline to detect the issues that impact the quality, relevance, or performance of the output. By leveraging feedback signals, a language model, and/or correlation techniques via the use of application logs and/or traces, some embodiments automatically attribute issues to specific pipeline stages and provide detailed diagnostic insights.

### BACKGROUND

Certain technologies, such as Large Language Model (LLM) based chatbots and complex conversational Artificial Intelligence (AI) systems, include data processing pipelines that process data in numerous pipeline stages. A data processing pipeline is a sequential or modular system that takes raw data as input, processes it through a series of stages or components, and produces a final output or result. For example, Multi-LLM Retrieval-Augmented Generation (RAG) pipelines may include the following stages—metadata enrichment, query rephrasing, intent understanding, information retrieval, passage re-ranking, LLM-based summarization, agent decision-making, and external tool interactions. Pipeline stages in a data processing pipeline work collaboratively to transform, retrieve, rank, and generate accurate responses by systematically refining user queries and/or ensuring that relevant information is efficiently processed and delivered.

Each of these pipeline stages contributes to the accuracy and efficiency of the system, but they are also potential points of failure or other issues. For instance, errors during query processing may propagate through the retrieval stage and result in irrelevant or incomplete responses. Similarly, incorrect ranking or LLM summarization can distort the final output. Existing technologies struggle to detect which pipeline stage is responsible for issues, leading to various technical problems, such as persistent inaccurate query results. Existing technologies also unnecessarily consume computing resources (e.g., via increased I/O and increased computing latency).

### SUMMARY

Embodiments of the present disclosure relate to AI-based attribution of issues to specific data processing pipeline stages. For instance, some embodiments detect and classify inefficiency issues, anomaly issues, and/or failure issues in a data processing pipeline, such as those used in conversational AI systems, search engines, or retrieval-augmented generation (RAG) frameworks. The system monitors various stages of the pipeline (e.g., query processing, retrieval, ranking, summarization, and response generation) to detect the issues that impact the quality, relevance, or performance of the output. By leveraging feedback signals, a language model (e.g., a Large Language Model (LLM)), and/or correlation techniques (e.g., via the use of application logs and/or traces), some embodiments automatically attribute issues to specific pipeline stages and provide detailed diagnostic insights to enable faster more accurate debugging and optimization.

Some embodiments first derive a feedback signal after a user query is processed through one or more data processing pipeline stages. This feedback signal represents an effectiveness metric for the pipeline stage(s), covering quality, relevance, and/or performance. Feedback signals can be explicit (e.g., user ratings or corrections), implicit (e.g., query reformulations, session abandonment), and/or system-generated performance metrics (e.g., retrieval ranking scores, model confidence scores, or latency measurements). For example, if a user repeatedly rephrases a query, this behavior is logged as an implicit feedback signal suggesting irrelevance or incorrect intent interpretation in the earlier pipeline stages.

The derived feedback signal is then processed by a language model classifier that categorizes the feedback signal into one or more predefined categories. These categories correspond to a respective issue type (e.g., an inefficiency type, anomaly type, or failure type) occurring at a specific pipeline stage. Examples of such predefined categories include “Incorrect Rephrasing,” “Irrelevance,” “Incorrect Re-Ranking,” “Incorrect or Irrelevant Citations,” and “Latency.” This classification is based on the language model's contextual understanding and pattern recognition capabilities. In some embodiments, the output includes confidence scores indicating the likelihood of each category, providing a preliminary stage attribution by linking issue categories to likely pipeline stages.

After the feedback classifier provides a preliminary attribution, some embodiments initiate a comprehensive review of session-based logs and/or traces to validate and/or refine the initial classification. Some embodiments retrieve relevant logs and/or traces by searching indexed log records using session identifiers, query IDs, timestamps, and/or pipeline stage metadata. This targeted retrieval ensures that only the relevant data is analyzed, reducing computational overhead and improving debugging efficiency. Some embodiments then detect one or more specific conditions that led to the classified issue by applying correlation techniques such as temporal correlation (aligning feedback timing with log events), semantic matching (analyzing log content), and/or causal dependency analysis (tracing event propagation).

Finally, some embodiments then present the classification results and/or detected conditions at a user device through a diagnostic interface or root cause report. In some embodiments, the interface provides a detailed breakdown of the issue category, corresponding data processing pipeline stages, confidence scores, supporting evidence from logs and traces, and/or recommended corrective actions. For example, if the issue was classified as Incorrect Retrieval due to query misalignment, the report may suggest adjusting the query rephrasing model or tuning retrieval ranking weights to improve semantic alignment with user intent. This enables developers and ML engineers to quickly resolve pipeline issues, ensuring that the issues are not only detected but also accurately attributed to the correct pipeline stage, leading to more efficient debugging and system optimization.

### BRIEF DESCRIPTION OF THE DRAWINGS

The present systems and methods are described in detail below with reference to the attached drawing figures, wherein:

FIG. 1 is a block diagram of an example system architecture, in accordance with some embodiments;

FIG. 2 is a block diagram of an example pipeline for detecting a condition associated with a failure, anomaly, and/or inefficiency in a data processing pipeline in a chatbot context, according to some embodiments;

FIG. 3 is a schematic diagram illustrating a Retrieval-Augmented Generation (RAG) pipeline that integrates enterprise data processing, vector-based retrieval, and LLM inference to generate user responses, according to some embodiments;

FIG. 4 is a block diagram illustrating how feedback classification predictions are mapped to specific application logs and traces and how correlation analysis uses such application logs and traces to derive a particular root cause report, according to some embodiments;

FIG. 5 represents of a screenshot of an example user interface page illustrating an interactive root cause report, according to some embodiments;

FIG. 6 is a flow diagram of an example process for tuning a language model to categorize a feedback signal into a category, according to some embodiments;

FIG. 7 is a flow diagram of an example process for generating an output that includes a classification of a feedback signal into one or more predefined categories, according to some embodiments;

FIG. 8A is a block diagram of an example generative language model system suitable for use in implementing at least some embodiments of the present disclosure;

FIG. 8B is a block diagram of an example generative language model that includes a transformer encoder-decoder suitable for use in implementing at least some embodiments of the present disclosure;

FIG. 8C is a block diagram of an example generative language model that includes a decoder-only transformer architecture suitable for use in implementing at least some embodiments of the present disclosure;

FIG. 9 is a block diagram of an example computing device suitable for use in implementing at least some embodiments of the present disclosure; and

FIG. 10 is a block diagram of an example data center suitable for use in implementing at least some embodiments of the present disclosure.

### DETAILED DESCRIPTION

As described above, existing technologies (e.g., chatbots, search engines, Internet of Things (IoT) networks, or conversational assistants) fail to adequately detect which pipeline stage is responsible for particular issues. Certain pipelines, such as complex retrieval augmented generation (RAG) pipelines, include multiple interdependent stages (query processing, retrieval, ranking, summarization, API calls, etc.). When an issue occurs (e.g., incorrect response, latency issues, system crash, etc.), it is unclear which stage caused the issue. Log management and observability systems of these technologies allow searching logs for error messages, response times, or failed API calls. However, these tools require engineers to manually search logs and execution traces to identify issues. Manually debugging the pipeline is arduous, time-consuming, and inefficient, requiring engineers to sift through large amounts of data and make assumptions.

Even when a potential issue is identified, logs and traces alone do not often provide clear insights into why the potential issue occurred. Engineers must manually correlate logs and system behavior to find the root cause, which is prone to errors, thereby leading to a misidentification of issue sources. Consequently, because the wrong part of the pipeline is changed (in hopes of fixing), the underlying issue that originally caused incorrect behavior in the data persists despite the changes. In an illustrative example, a chatbot may retrieve irrelevant documents, so the engineer adjusts the retrieval ranking algorithm on belief that retrieval ranking is the failure. However, the actual root cause or issue is the query rephrasing step that distorted the user's intent, causing retrieval to fetch the wrong documents. Accordingly, because of the wrong identification of the failure, the chatbot continues to retrieve incorrect information, even after retrieval ranking is modified. Accordingly, existing technologies facilitate developer error, which cause inaccuracies to persist in data processing pipelines.

Existing technologies also unnecessarily consume various computing resources. For instance, existing technologies unnecessary use CPU and I/O overhead. For example, log management and observability systems used in chatbots or AI conversational assistants require extensive CPU resources to perform full-text search and filter logs for debugging. These technologies must scan large volumes of system metrics/logs, which results in high I/O operations (e.g., resulting in wear and tear on a read-write head) and CPU spikes. Existing monitoring tools constantly track all metrics/logs, consuming CPU even when no issue occurs.

Further, existing technologies have higher query processing latency. Full log search, for example, is typically slow, especially for large-scale infrastructure logs. Manually correlating logs takes time, increasing developer debugging effort and system downtime. Further, cloud-based log analysis tools consume significant network bandwidth when transmitting logs from remote nodes.

Existing user interfaces are also generic and complex. Current issue reporting is scattered across logs, dashboards, multiple pages, and manual reports. Developers lack a single, centralized diagnostic interface that links user feedback, logs, traces, and issue classifications.

Various embodiments of the present disclosure help remedy one or more of these technical deficiencies (and/or other technical deficiencies) of these technologies described above. Particular embodiments are directed to AI-based attribution of issues to particular data processing pipeline stages. In operation, responsive to a user query being processed through at least one data processing pipeline stage (of multiple data processing pipeline stages), some embodiments derive a feedback signal. A “feedback signal” indicates an issue affecting the quality, relevance, and/or performance of at least one data processing pipeline stage. For instance, a feedback signal may be explicit user feedback (e.g., a thumbs up or thumbs down of a search result), an implicit user behavior signal (e.g., a user quickly reformulates a query after search results are generated indicating unsatisfactory results), or a system-generated performance metric (e.g., a low model confidence score, low retrieval ranking score, or unsatisfactory latency measurement).

In an illustrative example, a user first submits the query “Best wireless headphones under $100?” The query is then processed through multiple pipeline stages: a query rewriting stage (reformats the query for better retrieval), a retrieval stage (fetches relevant documents from a knowledge base), a ranking Stage (orders the results by relevance), and a summarization stage (an LLM generates a concise natural language response answer to the query for the user). Various embodiments then detect a feedback signal, such as the user clicking “Incorrect response” or gives a thumbs down on the generated answer.

After the feedback signal is detected, some embodiments generate an output comprising a classification of the feedback signal into one or more predefined categories based on a language model processing the feedback signal. Each predefined category corresponds to a failure, an inefficiency, and/or an anomaly at a respective data processing pipeline stage. For example, an LLM analyzes the relationship between the original and reformulated queries and recognizes that the retrieval results were incorrect due to poor query expansion. The LLM then classifies the feedback signal into a predefined category based on learned issue patterns. For instance, the LLM analyzes the relationship between the original and reformulated queries by computing semantic similarity scores and identifying meaning shifts between the two queries. It tokenizes, embeds, and compares both queries in a high-dimensional vector space, determining whether the reformulation altered the user's intent. If the reformulated query has a low cosine similarity to the original query or introduces keywords that significantly change intent outside of a threshold, the LLM flags a potential query processing failure. Additionally or alternatively, the model cross-references retrieved document embeddings (representing the search results) against the original query and reformulated query to detect misaligned retrieval results. If retrieved documents are more relevant to the reformulated query than the original, then some embodiments determine that the query expansion process distorted intent, classifying the issue as “Incorrect Query Reformulation” at the Query Processing Stage and “Irrelevant Document Retrieval” at the Retrieval Stage.

In some embodiments, the language model is able to make such classifications because it is trained (e.g., fine-tuned) or prompted (e.g., via prompt engineering or prompt tuning) to process multiple example input-output pairs (e.g., via few-shot learning), where each input-output pair comprises a respective feedback signal as an input and a corresponding predefined category as an output. For example with respect to fine-tuning, the language model generates vector representations of the feedback signals and categories within a latent feature space, applies a loss function to minimize the difference between the predicted category and the ground-truth category, updates model parameters using a supervised learning algorithm, a reinforcement learning algorithm, or a combination thereof to improve classification accuracy over time.

Once the language model classifies the feedback signal into a predefined category, some embodiments then detect one or more specific conditions associated with the failure, anomaly, or inefficiency by analyzing application logs and/or application traces. An application log is a structured record of system events, processes, and transactions generated by software applications, capturing execution details such as requests, responses, errors, timestamps, and performance metrics for monitoring, debugging, and issue analysis. An application trace is a sequential record of execution flow across multiple components or services in a system, capturing event timelines, dependencies, and contextual metadata to provide end-to-end visibility into request processing, latency, and issue propagation. A predetermined category is a high-level classification of an issue that maps or corresponds to a specific pipeline stage (e.g., “Incorrect Query Reformulation” for query processing failures or “Irrelevant Document Retrieval” for retrieval failures). In contrast, a specific condition is a detailed, contextualized root cause within that category, derived from log and trace analysis (e.g., “Query Expansion Mismatch: Reformulated query introduced unintended product category shift.”). While the category broadly indicates where the issue occurred, the specific condition explains why it happened, enabling targeted debugging and corrective actions.

In some embodiments, the process of detecting the specific condition involves log indexing, temporal correlation, semantic matching, and/or causal dependency analysis to isolate the root cause within the failing pipeline stage. For example, the LLM classifies the feedback signal as “Incorrect Query Reformulation” at the query processing stage and “Irrelevant Document Retrieval” at the retrieval stage. Responsively, the system fetches logs that capture the original and reformulated queries, transformation rules applied, and tokenization outputs. Logs show the retrieved document IDs, ranking scores, metadata annotations, and similarity scores. Temporal correlation, for example, aligns query processing logs and retrieval logs within the same session ID or timestamp window to detect where the issue originated. Semantic matching compares retrieved document embeddings (representing the search results) against both the original and reformulated queries to identify misalignment (e.g., retrieval ranking favored terms from the reformulated query but not the user's original intent). Causal dependency analysis determines if incorrect query expansion directly caused document (search result) retrieval failures, isolating the precise transformation rule or embedding function responsible. The logs reveal that the query rewriter incorrectly expanded “wireless headphones” to “Bluetooth earbuds,” altering the search intent. The retrieval system then ranks documents related to Bluetooth earbuds higher, despite the user originally searching for over-ear wireless headphones. This condition is recorded as “Query Expansion Mismatch: Reformulated query introduced unintended product category shift.”

Based on the detecting of the specific condition or the language model generating the output, some embodiments trigger one or more responses, such as generating a diagnostic report, updating a pipeline configuration parameter, and/or causing presentation of an indication of the issue (and/or other data) at a user interface. For example, upon detecting the specific condition “Query Expansion Mismatch: Reformulated query introduced unintended product category shift,” the system triggers several responses. First, it generates a diagnostic report that includes the classified category (e.g., “Incorrect Query Reformulation”), the affected pipeline stage (“Query Processing”), relevant logs (original vs. reformulated query), and detected condition to assist engineers in debugging. Lastly, the system presents an indication of the issue in the diagnostic user interface, displaying the issue classification, specific root cause (e.g., a failure condition), retrieved log details, and suggested corrective actions to guide developers in resolving the issue efficiently without burdensome user interface drilling.

Various embodiment of the present disclosure lead to various technical effects and advantages relative to existing technologies. For example, various embodiments automate issue detection in multi-stage data processing pipelines by leveraging a language model to classify failures, retrieving relevant logs/traces, and/or applying correlation techniques such as temporal, semantic, and causal dependency analysis. Unlike traditional log management tools that require manual searching and debugging, various embodiments automatically attribute issues to specific pipeline stages, eliminating guesswork and reducing developer effort. Accordingly, such automated issue detection is not as arduous, time-consuming, or inefficient, because engineers do not have to sift through large amounts of data and make assumptions.

Various embodiments also lead to another technical effect of less error rate or higher accuracy of data processing pipelines. Various embodiments eliminate the need for manual log correlation and prevents misidentification of issue sources by introducing a language model-based issue classification system that automatically detects, classifies, and maps issues to the correct pipeline stage. Instead of engineers guessing which part of the pipeline failed, various embodiments processes feedback signals, retrieves relevant logs, and/or applies correlation techniques (temporal, semantic, and/or causal dependency analysis) to pinpoint the exact root cause of failures. One or more of these operations ensures that only the affected pipeline stage is modified, preventing wasted debugging effort and persistent errors. In the chatbot example, instead of incorrectly adjusting retrieval ranking, embodiments would accurately classify the issue as a query rephrasing issue, allowing engineers to apply the correct fix immediately, ensuring that retrieval results improve, thereby improving the accuracy of query result generation.

Some embodiments lead to another technical effect—a reduction in CPU utilization and I/O overhead by eliminating the need for continuous full-text log searches and reducing unnecessary log processing. Instead of scanning all system logs and metrics, some embodiments derive a feedback signal and classify failures using a language model, allowing it to retrieve only the relevant logs and/or traces associated with a detected failure. Additionally or alternatively, correlation analysis (e.g., temporal, semantic, and/or causal dependency analysis) selectively processes log data, ensuring that CPU cycles and disk I/O operations are only used when necessary, rather than constantly tracking all logs and searching many more logs than are needed. This reduces I/O operations, CPU spikes, and improves overall system efficiency.

Various embodiments also have the technical effect of a reduction in query processing latency and a reduction in network bandwidth usage by eliminating the need for full log searches and manual correlation. Instead of scanning large-scale infrastructure logs, some embodiments classify issues using a language model, which then causes a retrieval of only the relevant logs and/or traces associated with the detected issue. By applying correlation techniques such as temporal alignment, semantic matching, and/or causal dependency analysis, some embodiments pinpoint failure/anomaly/inefficiency conditions without requiring exhaustive log comparisons. Additionally, in some embodiments, log retrieval is triggered only when needed, reducing unnecessary data transmission from remote nodes and lowering network bandwidth consumption, ultimately accelerating issue diagnosis and reducing system downtime.

Another technical effect is an improved user interface. One technical solution is a diagnostic interface that consolidates user feedback, logs, traces, issue classifications, and/or conditions into a single, structured view (e.g., a single user interface page summary), eliminating the need for developers to manually drill down to different pages or search across multiple dashboards and reports. Instead of presenting raw logs or scattered error messages, some embodiments automatically classify failures, retrieves relevant logs, apply correlation analysis, and/or generates a structured root cause report. In some embodiments, this report includes the affected pipeline stage, the classified category, supporting log evidence, root cause, and/or suggested corrective actions, allowing developers to quickly diagnose and resolve issues without navigating multiple tools or pages. This streamlined debugging workflow significantly improves efficiency and reduces resolution time.

### Example System Architecture

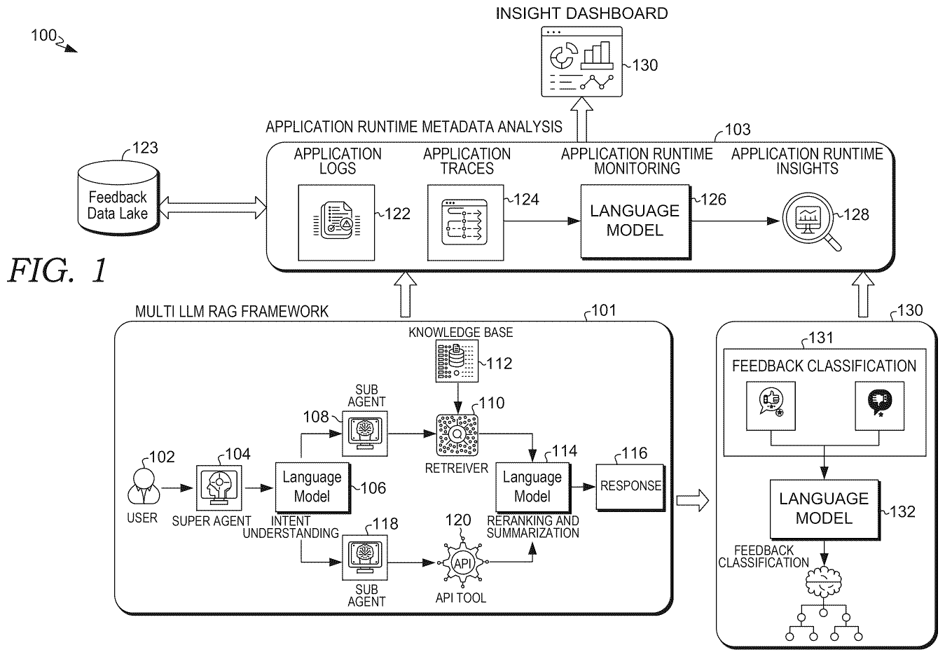

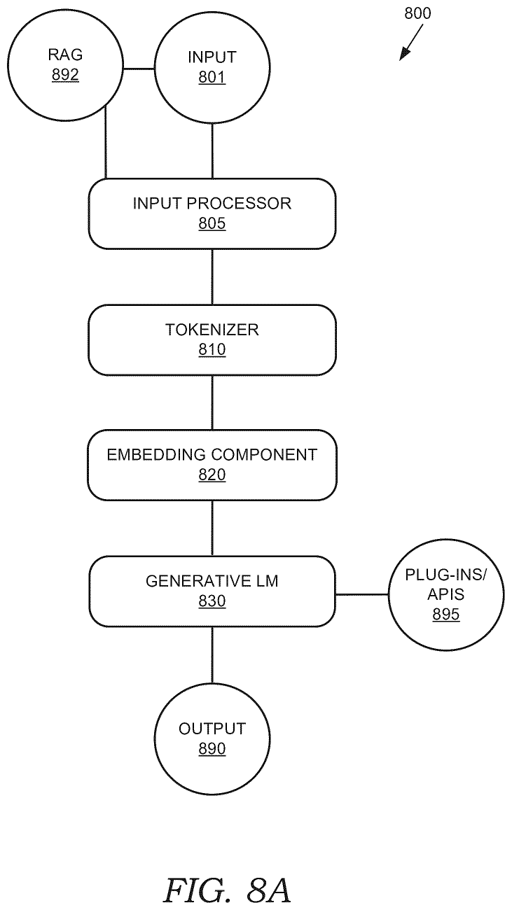

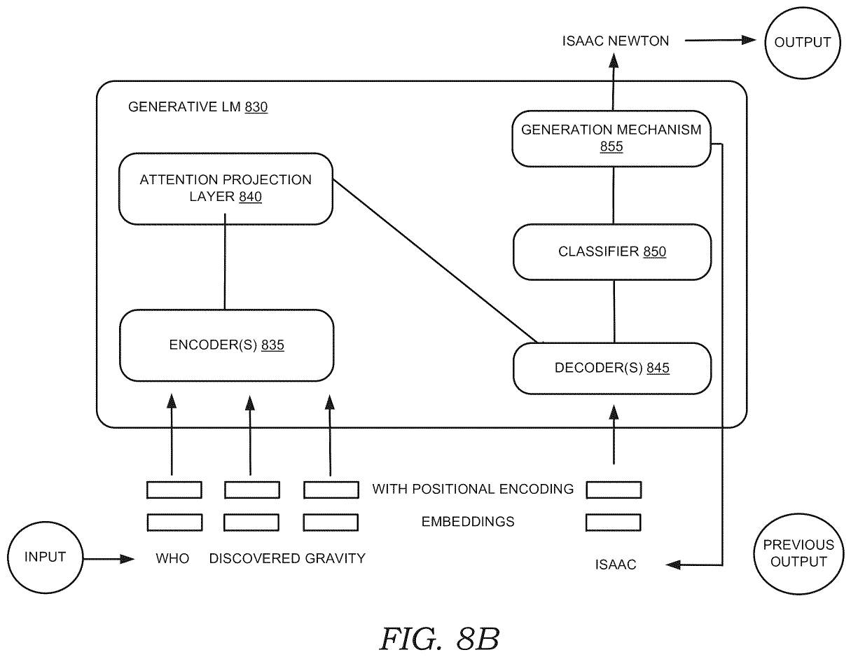

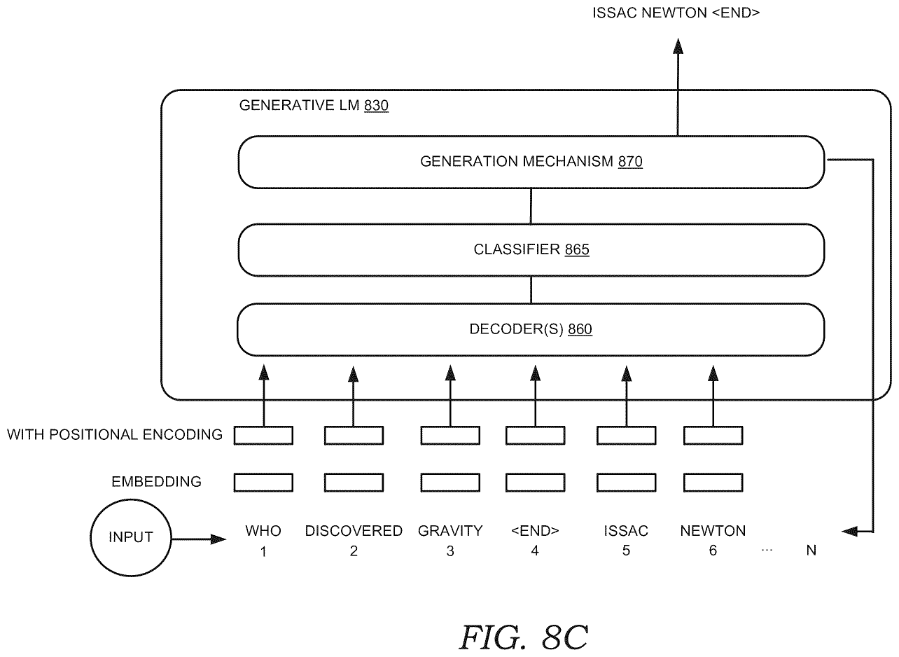

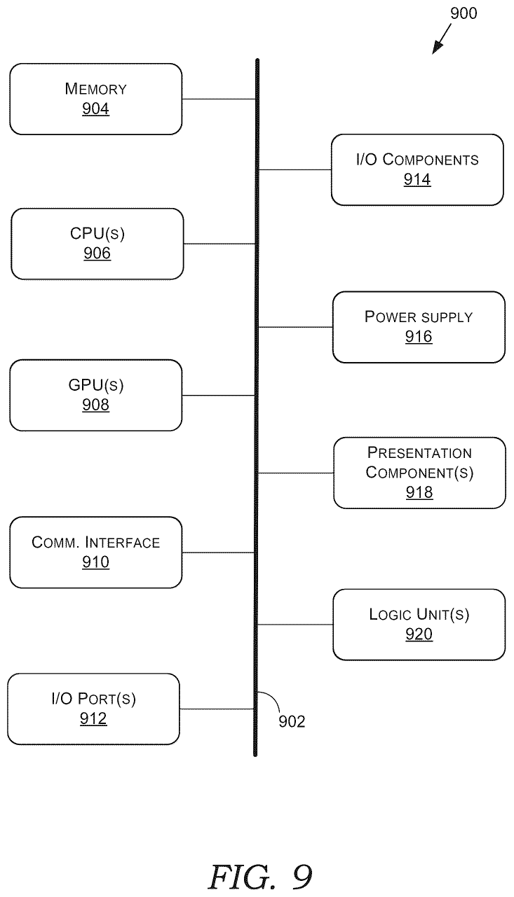

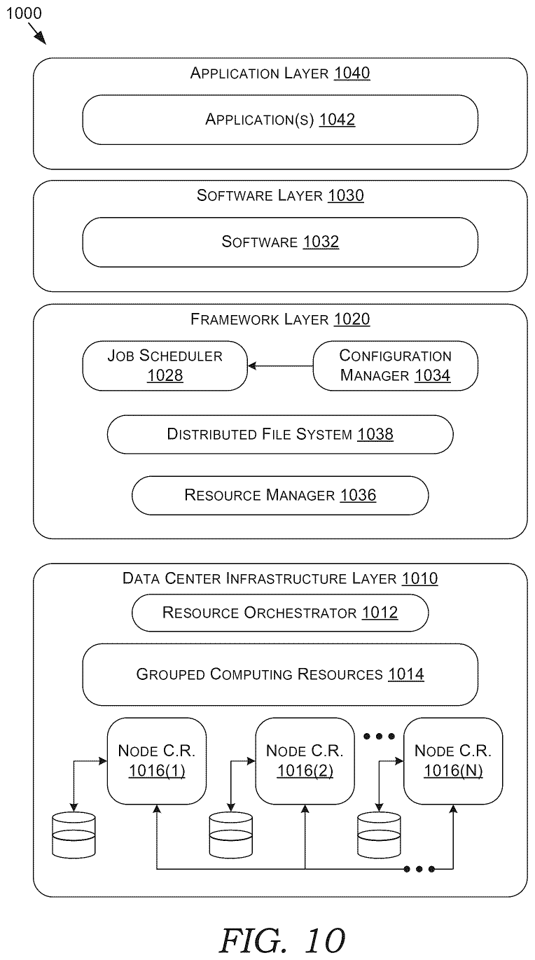

With reference to FIG. 1, FIG. 1 is a block diagram of an example system architecture (referred to as “system 100”), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example generative models/systems of FIG. 8A through 8C, the computing device of FIG. 9, and/or data center of FIG. 10.

In the embodiment illustrated in FIG. 1, the system 100 includes a multi LLM Retrieval Augmented Generation (RAG) framework 101, a feedback classification component 130, an application runtime metadata analysis component 103, and an insight dashboard 130. The system 100 is generally responsible for detecting a specific condition and presenting associated data to an insight dashboard 130, according to some embodiments.

At a first time, a Super Agent 104 receives the user query issued at a user device 102. The Super Agent 104 is generally responsible for orchestrating query flow and coordinates with the intent understanding language model 106, and sub-agents 108/118 to handle user queries. The input to the Super Agent 104 is a user query (e.g., natural language input), and session context (e.g., user profile, conversation history). The Super Agent 104 processes this information to refine the query sent to the intent understanding language model 106 for intent processing.

In an example illustration, the Super Agent 104 processes the user query by applying Natural Language Processing (NLP) preprocessing techniques such as text normalization, stop-word removal, entity recognition, and/or syntactic parsing to refine the input before passing it to the Intent Understanding model 106 (e.g., an LLM). The Intent Understanding model 106 (e.g., a first LLM) then uses semantic embedding techniques (e.g., transformer-based encoders like BERT or Sentence-BERT) to map the refined query into a high-dimensional vector space, where it is compared against predefined intent clusters. The model leverages few-shot learning, classification heuristics, and/or cosine similarity in embedding space to determine the most probable intent. For example, the query can read, “Can you show me cheap noise-canceling headphones?” The Super Agent 104 performs tokenization and normalizes the query by converting it to “cheap noise canceling headphones?” The Super Agent 104 detects “noise-canceling headphones” as a product category (via NER), and reformulates the query as “Find budget noise-canceling headphones.” The intent understanding language model 106 then engages in intent understanding by: embedding the query into a vector space and comparing it against intent categories (e.g., Purchase intent (“find budget products”)→0.92 similarity score, general product inquiry (“What are noise-canceling headphones?”)→0.74 similarity score) and then classifies intent as “Product Search” with high confidence. The output is a refined query sent to Sub-Agent 108;.

The sub agent 108 takes the structured intent output from the intent understanding language model 106 and optimizes it for retrieval. Specifically, the sub agent 108 optimizes the structured intent output for retrieval by applying query expansion, entity resolution, contextual enrichment, and/or retrieval constraint formulation. It takes the structured intent metadata from the intent understanding language model 106—which includes user intent, extracted entities, and/or constraints—and transforms it into a well-formed query suitable for the retriever. This process may involve synonym expansion, removing ambiguous terms, adding filters (e.g., price range, category restrictions), and/or restructuring query syntax to align with retrieval model expectations. For example, using the illustration above, the sub agent 108 adds synonyms such as “budget ANC headphones,” applies constraints, such as ensures price filter<$100, formats query for retrieval (e.g., “Retrieve top-rated noise-canceling headphones under $100”). The final output to the retriever 110, for example is “Find noise-canceling headphones OR ANC headphones where price<$100 and ranked by top-rated reviews.”

The retriever 110 is responsible for fetching relevant documents (search results) from the knowledge base 112 based on the query provided by sub agent 108. It operates as part of the retrieval-augmented generation (RAG) pipeline, ensuring that the system retrieves semantically relevant information to support downstream ranking and summarization. For example, the retriever 110 first converts the structured query from the sub agent 108 into an embedding representation (e.g., numbers that represent the structured query). Then the retriever 110 performs vector similarity search against the knowledge 112 base using techniques like cosine similarity, ANN (Approximate Nearest Neighbors), and/or BM25 scoring. The retriever 110, then retrieves a set of top-ranked documents based on similarity, such as semantic similarity. The retriever 110 applies pre-ranking filters (e.g., removes outdated or low-quality documents), metadata Enrichment (if applicable), and/or associates retrieved documents with contextual metadata to improve ranking and summarization. The output of the retriever 110 is retrieved Documents (Search Results), such as a ranked list of documents most relevant to the user query. Each document contains text content, metadata (e.g., source, date), and/or relevance scores. Relevance scores include a numerical confidence score indicating the degree of relevance of each document to the query. Documents may be enriched with metadata annotations that will be used in re-ranking and summarization.

The re-ranking and summarization language model 114 (e.g., a second LLM) takes the retrieved documents from the retriever 110 and/or response(s) from the API tool 120 as input and applies re-ranking algorithms and/or summarization techniques to generate a final response for the user. To do this, sub agent 118 acts as a specialized execution module that processes structured intent metadata from the intent understanding model 106 and determines whether external tools or APIs are required to fulfill the user request. Upon receiving the intent classification, extracted entities, and/or constraints from the intent understanding model 106, sub agent 118 analyzes whether the query necessitates calling an external tool (e.g., a price comparison API, a knowledge graph, or a dynamic database query). If an API call is needed, sub agent 118 formulates a structured API request by mapping extracted entities to API parameters, setting query constraints, and/or formatting the request syntax. Once the API request is structured, it is sent to the API tool component 120, which executes the query and retrieves external data. This enables the system to augment retrieved knowledge base results with real-time external information, ensuring more accurate and context-aware responses. Sub agent 118 thus analyzes structured intent metadata and entity types from the intent understanding language model 106 to determine if an external tool call is necessary. First, for example, it uses intent-based routing, where specific intent categories (e.g., “Price Lookup,” “Real-Time Weather,” “Stock Price Query”) are pre-mapped to API endpoints. If the detected intent matches an intent that requires dynamic data, the system triggers an external request. Second, it applies entity resolution and data source validation, where extracted entities (e.g., product names, locations, numerical values) are checked against predefined knowledge base coverage. If the information is not readily available in the internal knowledge base 112, sub-agent 118 forwards the request to the external API tool 120 for retrieval. “External data” refers to real-time, dynamic, and/or third-party information that is not stored within the system's static knowledge base 112. This includes, for example, live pricing from e-commerce APIs, current weather from meteorological services, stock market values from financial data providers, or updated sports scores from live feeds. Unlike pre-indexed knowledge base documents in 112, external data is fetched on demand to provide up-to-date responses.

The re-ranking and summarization language model 114 processes the retrieved documents from the retriever and any additional data (documents or search results) from the API tool 120 to generate a refined, contextually relevant response 116. First, for example, it applies re-ranking algorithms (e.g., BM25, dense retrieval embeddings, cross-encoder scoring) to prioritize the most relevant documents based on semantic similarity, metadata relevance, and/or recency. Then, it integrates external data (if available) by aligning structured API outputs with unstructured retrieved content. Once the most relevant content is selected, the re-ranking and summarization module 114 performs abstractive summarization, where it synthesizes information across multiple sources, removes redundancies, and generates a coherent, user-friendly response tailored to the query. This ensures that the final output is factually accurate, context-aware, and concise. For example, the final text summarization response 116 from the re-ranking and summarization model 114 may be, “The AirPods Pro (2nd Gen) are priced at $249.99 and offer active noise cancellation with transparency mode. Here are the top budget alternatives under $200.” In other words, the re-ranking and summarization language model 114 refines the retrieval process, prioritizes relevant data, and generates an informative response by synthesizing retrieved and real-time external data (e.g., via a text summarization function of an LLM).

As illustrated in FIG. 1, responsive to the multi LLM RAG framework 100 executes various stages (e.g., intent understanding via 106, retrieval via the retriever 110, re-ranking, summarization via 114, and API tool calls via 118 and 120), it logs pipeline events, latency measurements, model confidence scores, API response times, and/or retrieval relevance rankings. These logs 122 and traces 124 are ingested by the application runtime metadata analysis component 103, where they undergo runtime monitoring, anomaly detection, and correlation with feedback classifications, as described in more detail below. This enables proactive system diagnostics, allowing engineers to identify bottlenecks, model degradation, or recurring pipeline failures and optimize performance in real-time

After the re-ranking and summarization language model 114 generates the final response 116, the response 116 is sent to the user device 102, and simultaneously, a copy is fed into the feedback classification component 130 for evaluation. This component 130 collects one or more feedback signals 131, such as explicit feedback (e.g., thumbs up/down, user corrections) and implicit signals (e.g., query reformulation, prolonged response time, low engagement), and/or system-generated performance metrics such as retrieval confidence scores, response fluency, and API latency. The feedback classification model (e.g., a third LLM) then processes these signals and classifies the feedback signal(s) into a predefined category (e.g., “Incorrect Retrieval,” “Irrelevant Summarization,” “Latency Issue”), mapping it to the responsible pipeline stage. This classification is used to trigger log retrieval, trace analysis, and potential system adjustments at the application runtime metadata analysis component 103, enabling automated issue attribution and pipeline optimization.

In an illustrative example of how the feedback classification language model 132 functions, it processes feedback signals using a supervised or semi-supervised classification model, such as an LLM fine-tuned on historical issue cases. It ingests multiple input feedback signals, including explicit user feedback (binary or multi-class labels), implicit behavioral signals (e.g., query reformulation rates, response abandonment), and system performance metrics (e.g., retrieval confidence scores, latency spikes). These inputs are transformed into feature vectors and passed through the LLM, which applies semantic similarity matching, anomaly detection, and probabilistic classification to map the feedback to a predefined category. If confidence scores are low, the system may apply multi-pass self-refinement or request human-in-the-loop validation. The final classification is logged, correlated with pipeline traces, and used to adjust model parameters or retrieval heuristics dynamically.

Responsive to the feedback classification language model 132 generating a feedback classification output, the feedback classification component 130 calls the application runtime metadata analysis component 103 to perform a correlation analysis using the application logs 122, application traces 124 and/or the application runtime monitoring language model 126 (e.g., a fourth LLM). Upon the feedback classification model 132 generating a feedback classification output, the feedback classification component 130 triggers a request to the application runtime metadata analysis component 103 to perform correlation analysis using application logs, traces, and the application runtime monitoring model 126. In some embodiments, this correlation process begins by retrieving execution logs from 122 and traces from 124 associated with the specific query session, aligning timestamps, query identifiers, and pipeline stage metadata to trace the origin of the issue classification. The application runtime monitoring language model 126 then applies temporal correlation (matching feedback timestamps to pipeline events), semantic log analysis (identifying anomalies in retrieval, ranking, or response generation), and/or causal dependency analysis (tracing issue propagation across pipeline stages). The output of this correlation analysis provides fine-grained attribution of the condition, enabling developers to identify root causes, refine pipeline components, or automate corrective actions.

As illustrated in FIG. 1, the application runtime metadata analysis component 103 retrieves data (e.g., the application logs 122, application traces 124) from the feedback data lake. A structured data lake aggregates feedback signals, feedback classifications from the feedback classification language model 132, logs, and/or traces, allowing for both real-time insights 128 and retrospective trend analysis, supporting both immediate and long-term pipeline improvements. In other words, the feedback data lake 123 serves as a centralized storage system that aggregates feedback signals, classified categories, application logs, and/or execution traces to enable both real-time issue attribution and long-term trend analysis. The Application Runtime Metadata Analysis component 103 retrieves relevant historical logs and traces from the data lake to correlate failures with past system behavior, improving root cause detection accuracy. By maintaining structured storage of both raw and processed feedback data, the data lake 123 allows the system to detect recurring inefficiencies, refine pipeline tuning over time, and support adaptive retraining of classification models. Without the data lake 123, feedback insights may be limited to immediate issue detection, preventing the system from leveraging historical trends for proactive performance optimization across pipeline stages.

In some embodiments, the application runtime monitoring language model 126 applies temporal correlation by aligning timestamps from feedback classifications of the language model 132, query execution logs in 122, and system traces in 124 to detect when an issue (e.g., failure) event occurred relative to pipeline execution. In some embodiments, it then additionally or alternatively performs semantic log analysis (e.g., in 122 and 124), embedding log entries and comparing them to historical issue patterns to identify anomalies in retrieval scores, ranking inconsistencies, or model confidence fluctuations. Lastly, in some embodiments it additionally or alternatively applies causal dependency analysis by constructing event chains across pipeline stages, using probabilistic reasoning and network graph-based techniques to determine whether an upstream issue (e.g., a malformed query reformulation) caused a downstream issue (e.g., irrelevant retrieval results). The LLM generates application runtime insights 128, such as a failure attribution report, indicating the most probable root cause, confidence scores, and/or recommended corrective actions.

For fine-tuning or prompting of the language model 126, example input-output pairs (e.g., for few-shot learning) would include historical issue cases with associated logs and corresponding issue classifications. Inputs, for example, may include a log snippet containing a low retrieval ranking score, high model perplexity, and increased query reformulation attempts, paired with the feedback classification “Query Reformulation Error.” Expected outputs would include a structured diagnosis such as: “Based on the retrieved logs, user reformulation frequency, and retrieval scores, the issue is attributed to an incorrect query expansion rule, causing semantic drift in retrieval. Suggested action: Adjust entity linking threshold in Sub-Agent 1.” This structured feedback ensures the model learns to identify specific failure, anomaly, and/or inefficiency conditions and prescribe precise debugging recommendations.

The application runtime insights 128 are structured diagnostic outputs derived from real-time monitoring, log analysis, and/or correlation of feedback signals across pipeline components. The application runtime monitoring language model 126 generates these insights in some embodiments by continuously analyzing application logs 122, execution traces 124, and/or feedback classifications from the language model 132, detecting patterns in latency spikes, retrieval inconsistencies, ranking anomalies, and/or model confidence fluctuations. In some embodiments, the language model 126 applies anomaly detection models, probabilistic reasoning, and issue attribution techniques to transform raw runtime data into actionable insights, such as identifying performance bottlenecks, diagnosing pipeline failures, and recommending optimizations. These insights include root cause analysis, confidence scores, system health metrics, and suggested corrective actions, helping engineers interpret system behavior efficiently.

The insight dashboard-130 aggregates and visualizes these application runtime insights 128, presenting issue diagnostics and system performance metrics in a developer-friendly user interface. The dashboard 130 ingests structured outputs from the application runtime monitoring language model 126, mapping issue classifications to specific pipeline components and highlighting correlated anomalies over time. Engineers can use the dashboard to trace issue propagation across pipeline stages, compare historical issue trends, and apply recommended adjustments (e.g., tuning query expansion parameters, optimizing retrieval ranking, or adjusting API timeout thresholds). By centralizing issue analysis and system health monitoring, the insight dashboard 130 enables rapid debugging, real-time performance optimization, and proactive issue prevention.

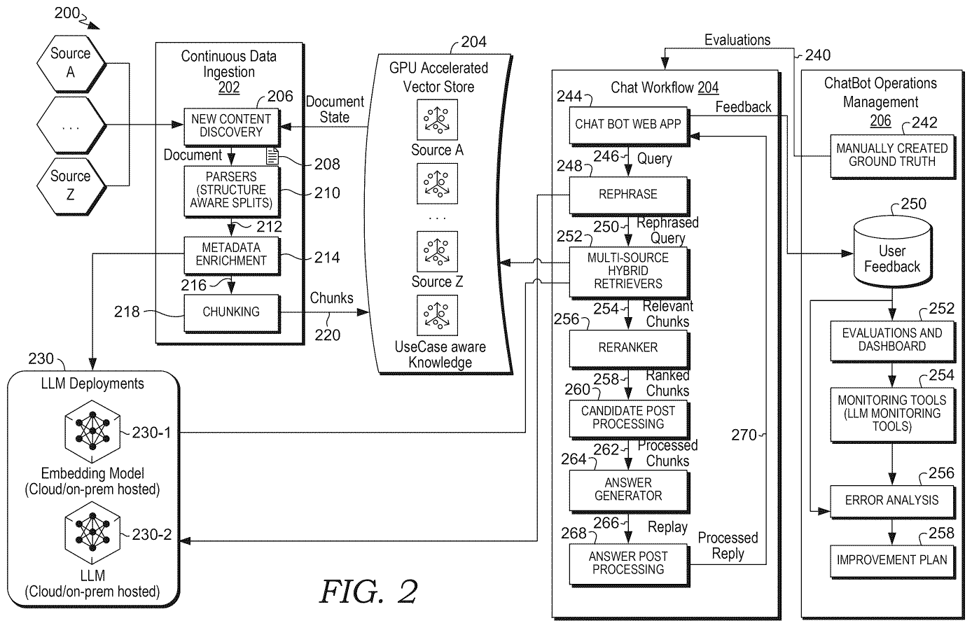

FIG. 2 is a block diagram of an example pipeline 200 for detecting a condition associated with a failure, anomaly, or inefficiency in a data processing pipeline in a chatbot context, according to some embodiments. The pipeline 200 is structured into three primary sections—a Continuous Data Ingestion (Preprocessing & Knowledge Base Update) 202, Chat Workflow (Query Processing & Response Generation) 204, and Chatbot Operations Management (Feedback Analysis & System Improvement) 206.

The Continuous Data Ingestion 202 is responsible for processes incoming documents (e.g., potential search results) from multiple sources (i.e., “source A” through “source Z”) before storing them in a vector database 204 for retrieval. New Content Discovery 206 detects new documents from sources (A→Z), such as web pages, PDFs, or structured reports. The output is a raw document(s) 208. For example, the new content discovery 206 engages in automated crawling, API-based ingestion, and/or event-driven data pipelines. It continuously monitors predefined data sources (e.g., web endpoints, document repositories, cloud storage) and listens for update events (e.g., a new file uploaded, a modified record in a database). Based on configurable rules, the new content discovery 206 extracts the raw document 208 content using HTTP requests, file system access, and/or streaming APIs and forwards it for preprocessing. If applicable, metadata (e.g., source type, timestamp, document ID) is attached for downstream processing. The output is an unprocessed raw document 208 that will later be parsed, enriched, and chunked for efficient retrieval.

The Parsers 210 (Structure-Aware Splits) is responsible for extracting semantic units (e.g., sections, paragraphs) from documents. It splits large documents into smaller, structured chunks. The output is semantic splits of text 212. For example, in some embodiments the parsers 210 applies rule-based, machine learning-based, and/or NLP-driven parsing techniques to detect headings, bullet points, numbered lists, and/or table boundaries within different document formats (e.g., PDFs, HTML, structured reports). For unstructured text, segmentation models analyze sentence coherence, topic shifts, and contextual markers to split large documents into smaller, retrievable chunks while maintaining logical continuity. The output is a set of semantic splits of text 212, each tagged with structural metadata (e.g., section title, position in document) to enhance downstream retrieval and ranking

Metadata Enrichment 214 is responsible for adding metadata (e.g., document type, source, timestamps). For example, Metadata Enrichment 214 may include labeling a section as “Financial Report Q1 2024.” The output is enriched text splits with metadata 216. The Metadata Enrichment component 214 takes the Semantic Splits 212 as input and makes a model call to the LLM Deployments 230 to extract and generate contextual metadata that enhances retrieval and ranking. Using named entity recognition (NER), topic modeling, and/or document classification, for example, the LLM 230-2 analyzes each text split 212 to identify key entities, categories, dates, authors, and relevant concepts. It additionally or alternatively predicts high-level attributes such as document type (e.g., research paper, legal contract, news article), sentiment, or domain relevance to improve downstream processing. The enriched metadata is then appended to each semantic split, resulting in Semantic Splits with Metadata 216, which enable efficient chunk indexing, filtering, and retrieval in the Vector Store 204.

After Metadata Enrichment 216 a model call is made to LLM deployments 230 while simultaneously the semantic splits with metadata 216 are sent to chunking 218. Chunking 218 divides enriched documents into smaller, retrievable segments. This enables efficient vector embedding and search retrieval in 204. The output is chunked text data 220 that gets sent to the vector store 204. For example, in some embodiments Chunking 218 includes fixed-size tokenization (e.g., sentence-based, paragraph-based, or dynamic length-based segmentation) and/or adaptive chunking algorithms (which consider sentence coherence and topic boundaries). This ensures that each chunk is self-contained and retains contextual meaning. These smaller segments are then optimized for embedding models, ensuring that the vector representations capture relevant semantic information without exceeding model input limitations. By chunking 218 the text effectively, the system improves retrieval granularity, allowing the retriever to return highly relevant content while minimizing irrelevant data. The output includes structured, indexed document chunks 220, ready for vectorization and retrieval in the next pipeline stage

The Vector Store 204 stores embedded document representations for fast retrieval. It uses vector similarity search to match queries to relevant chunks. The output is indexed vectorized document chunks. The Vector Store 204 converts chunked text 220 into high-dimensional vector embeddings using a pre-trained embedding model (e.g., BERT) and stores these representations in an indexed vector database for fast retrieval. When a query (e.g., a user query) is received, it is also embedded into the same vector space, and vector similarity search algorithms (e.g., cosine similarity, FAISS, HNSW, or approximate nearest neighbors (ANN)) are used to identify the most semantically relevant document chunks. The output is a ranked list of indexed vectorized document chunks, optimized for retrieval and downstream re-ranking.

The LLM deployments 230 includes an Embedding model 230-1 and an LLM 230-2. In some embodiments, although not explicitly illustrated in FIG. 2, the Embedding Model 230-1 is responsible for converting text chunks 220 (or semantic splits metadata 216) into high-dimensional vector representations that capture semantic meaning. Using pre-trained deep learning models (e.g., BERT, Sentence Transformers, OpenAI Embeddings, or Cohere), for example, it encodes enriched document chunks 220 into dense vector embeddings that can be stored in the Vector Store 204 for fast retrieval. When a query is received, it is also embedded into the same vector space, enabling efficient similarity search between queries and stored document chunks. This model 230-1 is useful for retrieval-augmented generation (RAG) workflows, allowing LLMs to ground their responses in retrieved knowledge.

The LLM 230-2 is responsible for understanding, processing, and generating responses based on both retrieved vectorized document chunks in 204 and direct user queries. It can perform tasks such as query rephrasing, text generation, summarization, reasoning, and ranking of retrieved content. The model 230-2 operates in conjunction with the retrieval pipeline, ensuring that generated responses are contextually relevant, factually grounded, and coherent. It is also used for intent recognition, response post-processing, and feedback classification in later stages of the pipeline. Accordingly, the Embedding Model 230-1 enables fast similarity-based retrieval, while the LLM 230-2 is responsible for interpreting and generating human-like responses based on retrieved knowledge.

Continuing with FIG. 2, the arrow labeled “Evaluations” 240 from “Manually Created Ground Truth” 242 to “Chat Workflow 204” indicates that ground truth data is used to evaluate and benchmark the chatbot's performance during live query processing. In some instances, this means that pre-annotated input-output pairs (e.g., correct responses, expected retrieval rankings, or labeled categories) are compared against real-time chatbot outputs to assess accuracy, relevance, and issue (e.g., failure) rates. The evaluation process may involve automated scoring metrics (e.g., BLEU, ROUGE, retrieval precision) or human-in-the-loop assessments, ensuring that the chatbot aligns with expected system performance. By integrating ground truth evaluations directly into the Chat Workflow, the system can continuously monitor LLM 230-2 and retrieval effectiveness, identify misclassifications, and improve response quality over time

The Chat Workflow (Query Processing & Response Generation) 204 handles user queries, captures feedback signal(s), retrieves relevant knowledge (from vector store 204), and generates responses (e.g., via the LLM 230-2). The Chatbot Web App 244 receives user query(s) 246 and passes them to processing stages while simultaneously detecting and/or sending user feedback signals 250 (e.g., explicit user feedback or implicit user behavior signals) to the chatBot operations Management component 206, and more specifically to evaluations and Dashboard 252.

The Evaluations and Dashboard 252 Aggregates the user feedback signals 250 for performance assessments and visual reporting on chatbot accuracy, user engagement, and/or issue trends. For instance, the Evaluations and Dashboard component 252 processes the user feedback signals 250 by collecting explicit responses (e.g., thumbs up/down, corrections) and implicit behavioral signals (e.g., query reformulations, response abandonment) to assess chatbot accuracy and performance. It aggregates this data alongside retrieval effectiveness scores, LLM response confidence from the LLM 230-2, and latency metrics to generate real-time analytics, issue heatmaps, and user engagement trends. These insights are visualized in a dashboard interface, allowing developers to track chatbot failures, analyze recurring issues, and compare real-time performance against predefined benchmarks. By continuously monitoring feedback-driven evaluations, the system can detect performance drift, prioritize issue resolutions, and guide iterative improvements to enhance chatbot reliability.

The Monitoring Tools (LLM Monitoring Tools) component 254 is generally responsible for real-time system performance tracking (e.g., API latency, LLM response times, retrieval ranking accuracy). They aggregate logs, execution traces, and/or anomaly detection results, flagging system-level issues like high issue rates in certain query types, increased processing delays, or API timeout spikes, or the like. The output of Monitoring Tools 254 serves as internal system performance metrics, which are then passed to Error Analysis 256. For example, if a chatbot experiences high latency in generating responses, the Monitoring Tools component 254 detects the issue by tracking API response times, LLM processing delays, and retrieval ranking inconsistencies. Suppose the average API response time spikes from 300 ms to 1.5 s, and the retrieval ranking confidence scores drop below a predefined threshold. The system 254 logs these anomalies and flags a potential condition, indicating that the retriever or external API might be underperforming. This internal system metric is then passed to Error Analysis 256, where it is correlated with user feedback signals 250 (e.g., users abandoning sessions due to slow responses). If the Error Analysis 256 (e.g., an LLM) identifies a pattern of latency-related failures, it may trigger a recommendation to optimize retrieval query efficiency, adjust LLM computational resources, or investigate API bottlenecks to improve response times.

In some embodiments, the Error Analysis component 256 includes or represents the functionality of the feedback classification language model 132 of FIG. 1 and/or the application runtime metadata analysis 103 of FIG. 1. For instance, the Error Analysis component 256 processes both system performance metrics from Monitoring Tools 254 and user feedback signals 250 to diagnose conditions and identify root causes within the chatbot pipeline. It ingests latency logs, retrieval ranking inconsistencies, API failure rates, and other internal performance metrics alongside explicit user feedback (e.g., downvotes, corrections) and implicit behavioral signals (e.g., query reformulations, abandoned sessions). Using an LLM-based classification model, it maps failures to predefined categories (e.g., “Slow API Response,” “Incorrect Retrieval,” “LLM Hallucination”) and applies temporal correlation, semantic log analysis, and causal dependency tracking to pinpoint the specific pipeline component responsible for degradation. The structured failure insights are then used to generate the Improvement Plan 258, which may recommend retrieval model adjustments, query expansion refinements, API optimizations, or fine-tuning of LLM parameters to enhance chatbot performance.

Continuing with FIG. 2, Query Rephrasing 248 reformulates the query 246 to optimize retrieval performance. For example, a user asks “Cheap noise-canceling headphones?” The Rephrase component 248 rephrases this sentence as “Budget ANC headphones under $100?” As described herein, restructuring or rephrasing may occur in any suitable manner. For instance, the Rephrase component 248 takes the user query 246 as input and performs a model call to the LLM Deployments 230 to generate a semantically refined, retrieval-optimized version of the query. It leverages LLM-based (i.e., 230-2) paraphrasing, synonym expansion, and/or intent preservation techniques to restructure the query 246 while maintaining its original meaning. This process helps improve retrieval performance by eliminating ambiguity, expanding abbreviations, correcting grammar, and reformatting queries to align with the retrieval model's expectations. The output is a restructured query 250, optimized for the Multi-Source Hybrid Retrievers 252, ensuring higher-quality document retrieval and more relevant chatbot responses.

The Multi-Source Hybrid Retrievers component 252 takes the Rephrased Query 250 as input and performs a model call to the LLM Deployments 230 alongside querying the Vector Store 204 to retrieve the most relevant information. In some embodiments, it employs a hybrid retrieval strategy, where it first executes dense vector similarity search in the Vector Store 204 to fetch semantically relevant document chunks. Simultaneously, it calls the LLM 230-2 to enhance retrieval by expanding the query 250, ranking potential results, or retrieving structured knowledge from external sources (e.g., APIs, knowledge graphs). The LLM 230-2 may also assist in retrieval augmentation by re-ranking or filtering results before returning them. The output is a set of highly relevant chunks 254, which are passed to the Reranker 256 for further refinement and prioritization.

The Reranker 256 refines the Relevant Chunks 254 retrieved by the Multi-Source Hybrid Retrievers 252 by applying deep semantic scoring models, cross-encoder ranking, and/or contextual relevance evaluation to prioritize the most useful information. It takes the initially retrieved document chunks and re-evaluates their importance by assessing query-chunk similarity using models, such as transformer-based models (e.g., ColBERT, MonoT5, or cross-encoder BERT ranking). The reranking process considers semantic closeness, passage coherence, retrieval confidence scores, and/or entity alignment to reorder the chunks, ensuring that the most contextually relevant segments are prioritized for downstream processing. The output is a list of Ranked Chunks 258, which are then passed to Candidate Post Processing 260 to prepare them for final response generation.

The Candidate Post Processing component 260 refines the Ranked Chunks 258 by applying text deduplication, coherence filtering, and/or structural cleanup, ensuring that only high-quality, non-redundant, and/or contextually relevant chunks are retained before passing them as Processed Chunks 262 to the Answer Generator 264 for final response synthesis. For example, if the Ranked Chunks 258 contain overlapping content from multiple sources—such as two different documents both stating “The AirPods Pro 2 feature Active Noise Cancellation”—the Candidate Post Processing component 260 detects this redundancy and removes duplicate or conflicting passages. Additionally, if a chunk contains incomplete or fragmented text, such as “ . . . and these features make it the best choice for . . . ,” it may be discarded or restructured to improve coherence. The final Processed Chunks 262 ensure that the Answer Generator 264 receives clean, non-repetitive, and well-structured text for generating a high-quality response.

The Answer Generator 264 takes the Processed Chunks 262 as input and synthesizes a coherent, contextually relevant response by performing a model call to the LLM Deployments 230. It first formats the retrieved text into a structured prompt, integrating salient facts, extracted entities, and contextual markers to guide the LLM 230-2 in generating an informative reply. The LLM (hosted on-prem or in the cloud) 230-2 then processes the input using instruction-following, abstractive summarization, and/or retrieval-augmented generation (RAG) techniques to generate a natural language response. The output reply 266 is designed to be factually grounded in the retrieved chunks, ensuring relevance while minimizing hallucinations. Once generated, the reply 266 is passed to Answer Post Processing 268 for refinement before being delivered to the user.

The Answer Post Processing component 268 takes the Reply 266 generated by the Answer Generator 264 and applies one or more refinement techniques to ensure clarity, coherence, and/or factual accuracy before delivering the Processed Reply 270 to the Chat Bot Web App 244. This includes, for example, grammar and fluency checks, redundancy removal, hallucination detection, and/or response truncation to ensure the output remains concise and relevant. If applicable, it may also perform formatting adjustments, such as structuring the response into bullet points or highlighting key facts. Additionally, confidence scoring and response validation may be applied to filter out unreliable responses before finalizing the processed output. The refined Processed Reply 270 is then sent back to the Chat Bot Web App 244, ensuring an optimal user experience.

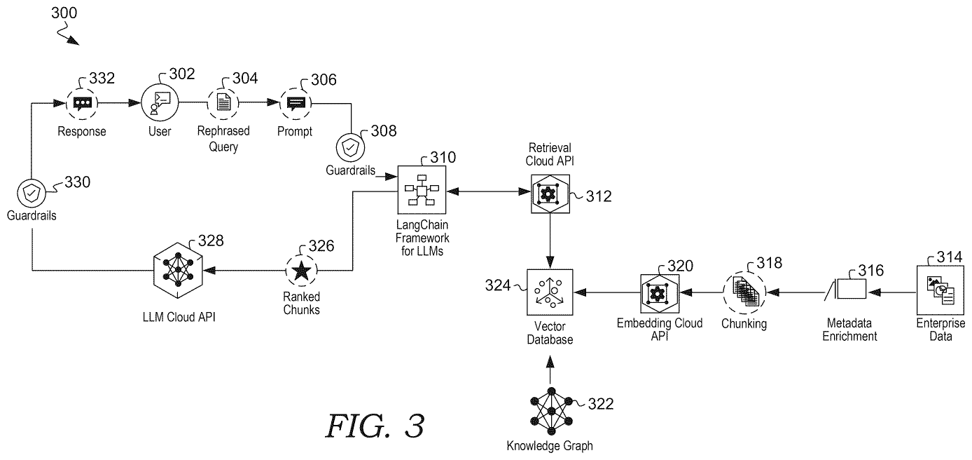

FIG. 3 is a schematic diagram illustrating a Retrieval-Augmented Generation (RAG) pipeline 300 that integrates enterprise data processing, vector-based retrieval, and LLM inference to generate user responses, according to some embodiments. FIG. 3 illustrates the types of pipelines that can be included in the Multi LLM RAG Framework 101 of FIG. 1 and their corresponding data that can be tracked in the application logs 122 and the application traces 124 of FIG. 1.

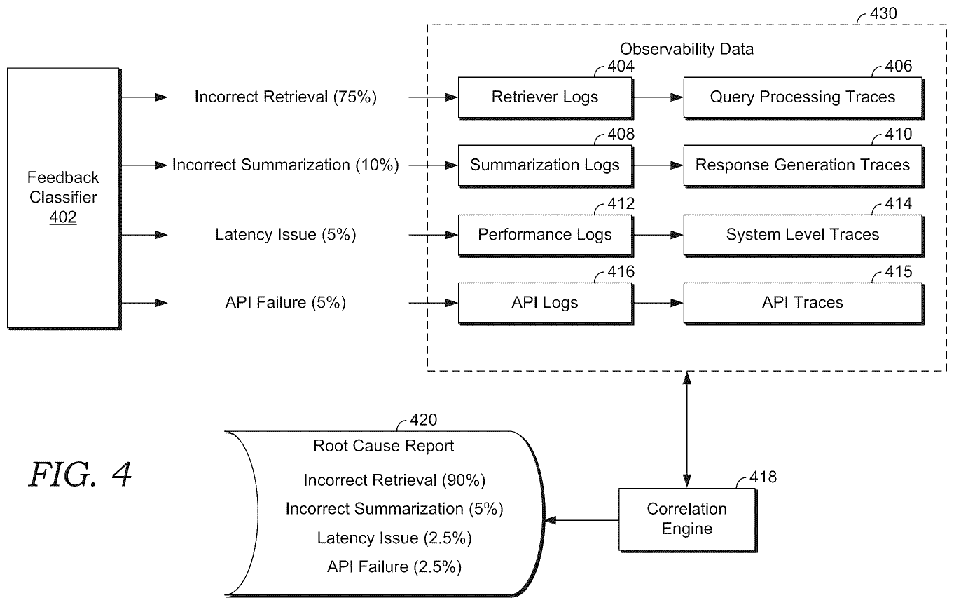

At a first time the User 302 (or user device) issues a query, which gets converted or restructured into a Rephrased Query 304 (e.g., via the Rephrase component 248 as described with respect to FIG. 4). The Rephrase Query 304 then gets included in the prompt 306. The Prompt 306 is generated by taking the Rephrased Query 304 as input and structuring it into a format optimized for language model (e.g., LLM) processing. This involves applying prompt engineering techniques, such as context injection, role-based instructions, and retrieval augmentation, to ensure that the LLM interprets the query accurately. The system may also incorporate additional context from previous interactions, user preferences, or predefined templates to enhance the query's specificity. For example, if a user submits a query “What are the latest AI trends in 2024?” the system applies a predefined prompt template for an information retrieval task, such as: “You are an expert AI analyst. Based on the retrieved knowledge, summarize the latest AI trends in 2024 with a focus on advancements in machine learning, generative AI, and industry adoption.” This template ensures that the Prompt 306 is structured to guide the LLM effectively, aligning the response with the desired format and scope. Additionally, contextual metadata (e.g., user preferences, query history, or retrieval source confidence scores) may be appended to refine the Prompt 306 further. Once structured, the Prompt 306 is passed through the Guardrails module 308.

The Guardrails 308 takes the Prompt 306 as input and applies one or more of a series of content moderation, compliance enforcement, and/or response validation techniques before passing it to the LangChain Framework for LLM 310. This module ensures that the Prompt 306 adheres to predefined ethical, legal, and/or security constraints, such as filtering out harmful content, personally identifiable information (PII), or biased language. Additionally, it may enforce policy-based constraints, such as ensuring responses align with enterprise guidelines or restricting queries related to sensitive topics. Using rule-based filtering, LLM-powered moderation, or reinforcement learning techniques, the Guardrails module 308 refines the Prompt 306 to prevent harmful or misleading outputs. Once validated, the sanitized and policy-compliant Prompt is forwarded to the LangChain Framework 310, where it is processed for retrieval and LLM inference.

The LangChain Framework 310 takes the sanitized and policy-compliant Prompt from the Guardrails module 308 and orchestrates the retrieval-augmented generation (RAG) process by interacting with the Retrieval Cloud API 312. In some embodiments, it first parses the prompt, determines retrieval requirements, and issues a query to the Retrieval Cloud API 312, which then searches for document embeddings (representing search results) in the Vector Database 324 (e.g., the Vector Store 204 of FIG. 2) that are relevant to the policy-compliant prompt. Once the Retrieved Chunks 326 are returned, the Framework 310 applies re-ranking techniques, such as cross-encoder scoring, metadata filtering, and/or semantic similarity matching (e.g., via Cosine distance), to ensure that the most relevant results are prioritized. The Ranked Chunks 326 are then passed to the LLM Cloud API 328 via LLM calls, where they are used as contextual input for final response generation.

The LLM Cloud API 328 (e.g., NVIDIA's Inference Microservice-NIM) takes the Ranked Chunks 326 as input and generates a contextually relevant response by leveraging retrieval-augmented generation (RAG). In some embodiments, the LLM Cloud API 328 represents the LLM Deployments 230 of FIG. 2, the re-ranking and summarization model 114, and/or the intent understanding language model 106 of FIG. 1. The LLM processes the ranked document chunks alongside the original prompt, synthesizing a coherent, fact-based response while minimizing hallucinations. It applies natural language understanding (NLU), abstractive summarization, and/or knowledge fusion techniques to ensure the output aligns with the retrieved information. Before returning the response 332 to the user, the LLM Cloud API 328 sends the generated text to the Guardrails module 330, where it undergoes compliance checks, safety filtering, and bias detection to ensure adherence to policy constraints before final delivery.

The Enterprise Data 314 represents a structured repository of internal business documents, knowledge bases, reports, and/or other proprietary datasets that serve as the foundation for retrieval-augmented generation (RAG). This data is ingested and processed through the Metadata Enrichment component 316 (e.g., as described with respect to the Metadata Enrichment 214 of FIG. 2), where it undergoes automated tagging, classification, and/or entity recognition to enhance its retrieval capabilities. For Metadata Enrichment 316, the system extracts key metadata attributes, such as document type, source, author, timestamp, topic categories, and/or entity references, using rule-based processing, LLM-driven entity extraction, and/or predefined taxonomies. This enriched metadata ensures that downstream retrieval models can efficiently filter, rank, and surface the most relevant information during query processing.

The Chunking component 318 (e.g., as described with respect to the Chunking 218 of FIG. 2) takes the Metadata Enrichment output as input and divides the enriched enterprise data into smaller, contextually meaningful segments to optimize retrieval and embedding efficiency. Using rule-based segmentation, NLP-based sentence boundary detection, and/or dynamic chunking algorithms, it ensures that each chunk preserves semantic coherence while maintaining a manageable token size for embedding models. Chunking also aligns with metadata annotations, ensuring that contextual attributes (e.g., document type, timestamp, or topic tags) remain associated with each chunk. The processed text chunks are then passed to the Embedding Cloud API 320, where they are converted into high-dimensional vector representations for storage in the Vector Database 324, enabling fast and accurate retrieval.

The Knowledge Graph 322 enhances the Vector Database 324 by providing structured, interconnected relationships between entities, concepts, and metadata within the enterprise data. The Knowledge Graph 322 is structured as a network of nodes and edges, where nodes represent entities (e.g., concepts, people, organizations, technologies) and edges define relationships between them (e.g., “AI enables Predictive Analytics,” “Financial Institutions use Risk Models”). Each node can store metadata attributes (e.g., category, description, source confidence), while edges can have weights or labels indicating the strength or type of relationship. The graph supports semantic linking, reasoning, and inference, allowing the system to dynamically expand queries and improve retrieval relevance by leveraging entity relationships.

When new information is stored in the Vector Database 324, the Knowledge Graph 322 is used to link related entities, infer semantic relationships, and improve retrieval accuracy by offering context-aware query expansion and entity disambiguation. During retrieval, the Vector Database 324 can leverage the Knowledge Graph's 322 structured data to refine search results, ensuring that queries retrieve not only semantically similar document chunks but also contextually relevant knowledge based on established relationships. This integration enhances the precision and depth of information retrieval for downstream LLM processing. In an illustrative example, if a user queries, “What is the impact of AI on financial risk management?” the Vector Database 324 retrieves semantically similar document chunks, but the Knowledge Graph 322 enhances the search by identifying related entities such as “machine learning models,” “fraud detection,” and “regulatory compliance.” If the retrieved chunks mention “predictive analytics” but not explicitly “financial risk management,” the Knowledge Graph 322 infers the connection and expands the retrieval scope to include documents (search results) discussing “AI-powered credit scoring” and “algorithmic trading risks.” This ensures that the system retrieves both direct matches and semantically relevant information, improving the response quality for the LLM.

Each of the components of the pipeline 300 represents different stages in a data processing pipeline. When a user submits feedback (explicit or implicit), the system can use the same retrieval pipeline 300 to locate relevant logs, traces, and execution metadata that correspond to the query processing stages where an issue occurred. For instance, if a user flags a response as irrelevant, the retrieval system can identify ranked chunks, embeddings, and retrieval scores, allowing the Feedback Classification LLM (e.g., 132) to assess whether the issue originated from query rephrasing 304, document retrieval via 312, or answer generation for the response 332.

The Application Runtime Metadata Analysis 103 can further enhance issue diagnosis by using logs, execution traces, and performance metrics collected at each pipeline stage of the pipeline 300 of FIG. 3. When an issue occurs, logs from retrieval queries, vector similarity scores, LLM inference calls, and response generation can be correlated with feedback classification to identify systemic issues. For example, if retrieved chunks consistently contain low-confidence matches, logs may reveal indexing inefficiencies, suboptimal embeddings, or ranking misconfigurations. By integrating structured knowledge (from the Knowledge Graph) and real-time logs, the system can automate issue attribution, root cause analysis, and pipeline optimizations in response to user feedback or system anomalies.

FIG. 4 is a block diagram illustrating how feedback classification predictions are mapped to specific application logs and traces and how correlation analysis uses such application logs and traces to derive a particular root cause report, according to some embodiments. At a first time the feedback classifier 402 classifies a particular feedback signal into one of four predetermined categories as illustrated by an associated confidence score—“incorrect retrieval (75%),” “incorrect summarization (10%),” “latency issue (5%),” “API failure (5%).” This indicates that the classifier 404 is 75% confident that the issue is incorrect retrieval based on the feedback signal received, which is higher than any other category. It is understood that there may be more or fewer classification categories than represented in FIG. 4. For example, the predetermined categories may additionally or alternatively be incorrect rephrasing, irrelevance, incorrect ranking of retrieved passages, incorrect or irrelevant citations, and/or latency. In some embodiments, the feedback classifier 402 represents the feedback classification model 132.

In an illustrative example of the functionality of the feedback classifier 402, it may be an LLM that processes the feedback signal by leveraging natural language processing (NLP) techniques, such as semantic similarity matching, intent recognition, and context-aware classification. The model first tokenizes and embeds the feedback text using a transformer-based architecture (e.g., BERT, T5, or GPT-derived models) to extract semantic meaning. Then, it compares the embedded representation of the feedback with pre-trained issue mode patterns using a softmax classification layer that assigns probability scores to each of the four predetermined categories. For example, if the user feedback states, “The response was completely off-topic and didn't match my query,” the model detects semantic misalignment with the retrieved documents and assigns a high probability (75%) to “Incorrect Retrieval”, while low scores are assigned to “Incorrect Summarization“ (10%), “Latency Issue” (5%), and “API Failure” (5%) due to lack of supporting linguistic features. The output is a confidence-weighted classification, which is then passed to the correlation engine 418 for further root cause analysis using logs and traces.

In some embodiments, the distance in the feedback classifier 402′ embedding space maps to the confidence scores in classification tasks, particularly when using softmax-based probability distributions or distance-based scoring methods (e.g., cosine similarity, Euclidean distance). In transformer-based models, feedback and predefined categories are represented as high-dimensional embeddings in a shared vector space. When classifying feedback signals, the model computes the distance between the feedback embedding and each category prototype embedding (which represents a cluster of similar past issue cases). A smaller distance (higher cosine similarity) to a particular category increases the probability score for that class. The softmax function then normalizes these distances into a confidence score distribution across all categories. For instance, if the feedback embedding closely aligns with the “Incorrect Retrieval” category, it receives a higher confidence score (e.g., 75%), while categories that are farther in the embedding space (e.g., “Latency Issue” or “API Failure”) receive lower scores (e.g., 5%) due to weaker semantic alignment.

In some embodiments, all of the observability data 430 is used by the correlation engine 418. Alternatively, in some embodiments, because the classifier 402 outputs “Incorrect Retrieval” with confidence (e.g., 75%) above a threshold or higher than any other feedback category, it signals that the issue likely occurred during the retrieval stage of the data processing pipeline, prompting the system to only examine Retriever Logs 404 and/or the “query processing traces” 406 (and not read any other of the summarization logs 408, the response generation traces 410, the performance logs 412, the system level traces 414, the API logs 416, and/or the API traces 415). Conversely, if the classifier 402 had assigned a high confidence score to “Incorrect Summarization,” for example, the system would instead only analyze Summarization Logs 408 (which track ranked passage selection and output coherence) and/or “Response Generation Traces” 410. In some embodiments, this log and trace selection process is automated using a rule-based or model-driven log/trace routing mechanism, ensuring that only relevant logs and traces are retrieved for correlation analysis, reducing unnecessary computation and improving debugging efficiency. In an illustrative example, the system incorporates conditional logic, such as if-then rules or model-driven routing, to determine which logs and traces to analyze based on the feedback classifier 402's output. For example, if the classifier assigns a high confidence score to “Incorrect Retrieval,” the system executes a predefined rule:
IF classification=“Incorrect Retrieval”
   →THEN examine “Retriever Logs” AND “Query Processing Traces”
ELSE IF classification=“Incorrect Summarization”
   →THEN examine “Summarization Logs”
ELSE IF classification=“Latency Issue”
   →THEN examine “API Logs” AND “System Performance Traces”

This automated log-routing mechanism reduces unnecessary log scans and optimizes issue correlation by dynamically selecting the most relevant observability data based on the category assigned by the classifier. In more advanced implementations, a separate machine learning model could refine log selection by learning from past debugging patterns, further improving efficiency.

Retriever logs 404 store records of retrieved document IDs, ranking scores, and/or metadata annotations used during the retrieval process. These logs help diagnose issues related to incorrect document selection, missing results, or relevance mismatches. Query processing traces 406 capture the execution flow of query transformations, reformulations, and retrieval execution steps. These traces help track how a user query was modified and processed before retrieval, identifying potential misinterpretations.

Summarization logs 408 contain details about ranked passages, extracted key points, and generated summaries from the retrieved documents (search results). They help identify content omissions, misinterpretations, or hallucinations in summarization. Response generation traces 410 track the step-by-step execution of the language model (e.g., LLM) response generation process, including token-by-token generation, retrieval integration, and reasoning steps. These traces help diagnose hallucinations, incomplete answers, or slow response times.

performance logs 412 record latency, memory usage, and computational efficiency metrics across different pipeline stages. These logs help identify system bottlenecks, high-latency operations, and resource-intensive processing steps. system-level traces 414 capture low-level infrastructure execution details, including pipeline dependencies, workload balancing, and service orchestration. They help debug failures related to system-level scaling, container failures, or unexpected processing delays.

API logs 416 store request-response details, status codes, and response times for external API calls. These logs help diagnose failed API calls, slow third-party integrations, or incorrect data retrieval. API traces 415 capture the sequential execution path of API calls, tracking how requests propagate through different microservices or external systems. These traces help analyze API latency spikes, dependency failures, and unexpected request routing issues.

The correlation engine 418 processes observability data 430 from the application logs and application traces to identify issue points within the pipeline by applying temporal correlation, semantic log matching, and/or causal dependency analysis. It first aligns feedback signal timestamps with log and trace events to determine which pipeline stage was active when the issue occurred. Then, it cross-references execution traces with logs to detect anomalies, such as unexpected API failures, ranking mismatches, or latency spikes. By analyzing log patterns, query dependencies, and execution flows, the engine quantifies issue likelihood and generates a structured root cause report 420, ranking potential causes with confidence scores.

With respect to the root cause report 420, the correlation engine 418 refines the initial classification by analyzing application logs and/or traces, using advanced correlation techniques such as temporal correlation, semantic matching, and/or causal dependency analysis. The feedback classifier provides an initial set of confidence scores based on the feedback signal alone as illustrated in FIG. 4, but it does not have full visibility into the internal pipeline states and events. Once the correlation engine 418 cross-references the feedback with session-specific logs and/or traces, it detects specific conditions that better explain the issue. For example, the logs may reveal that the retrieved documents had low semantic similarity to the user's intent, and the query processing traces show that a query rephrasing step distorted the original intent, leading to incorrect retrieval. This evidence increases the confidence score for Incorrect Retrieval to 90% while lowering the scores for other categories as they are less likely root causes, as illustrated in the root cause report 420. This dynamic adjustment ensures that the system provides more accurate and explainable issue attribution. In some embodiments, the updated confidence score is computed using Bayes' theorem, where the prior probability is the classifier's initial confidence (e.g., 75% for Incorrect Retrieval), and the likelihood is derived from correlation evidence (e.g., low semantic similarity, ranking anomalies). This probabilistic adjustment redistributes the confidence scores across all categories, increasing the confidence in categories strongly supported by log evidence and decreasing it for others, ensuring more accurate root cause attribution.

Algorithmically, cross-referencing retriever logs 404 with query processing traces 406 involves query identifier matching, semantic similarity analysis, and dependency tracking in some embodiments. First, the correlation engine 418 extracts the Query ID from both the retriever logs 404 and query processing traces 406 to align log entries with execution traces. Then, semantic similarity techniques (e.g., cosine similarity on query embeddings) are applied to compare the original user query with the rephrased query stored in the traces. If the semantic distance between the original and transformed query is high or over a threshold, this signals a potential misinterpretation in query reformulation. Additionally, causal dependency graphs may be used to trace retrieval results back to query modifications, allowing the system to detect whether query expansion, stop-word removal, or paraphrasing contributed to incorrect retrieval, for example.

In some embodiments, the correlation engine 418 represents or uses an LLM (e.g., GPT, T5, or BERT variants) to analyze retriever logs, query traces, and execution logs. For example, it applies natural language understanding (NLU) on logs and traces to extract meaningful patterns, and/or uses zero-shot or few-shot learning to infer causal relationships between failures and pipeline stages. For example, LLMs may be useful when detecting subtle query-retrieval mismatches, where query reformulation leads to incorrect document ranking due to an intent drift. In alternative or additional embodiments, the correlation engine 418 represents or uses a Graph-Based Causal Inference Model for structural correlation. These are useful when the system needs structured dependency tracking across logs and traces. For example, these structures may represent data processing pipeline execution as a causal graph (DAG-Directed Acyclic Graph). Nodes represent pipeline components/stages (retrieval, ranking, summarization, API calls), and edges represent causal dependencies. Some embodiments use Bayesian Causal Inference or Structural Equation Models (SEM) to detect anomalies and trace root causes. For example, if retrieval ranking drops, the model checks if query reformulation or vector embedding misalignment caused the issue. It is understood that any suitable model may be used instead of or in addition to LLMs and graph-based models.

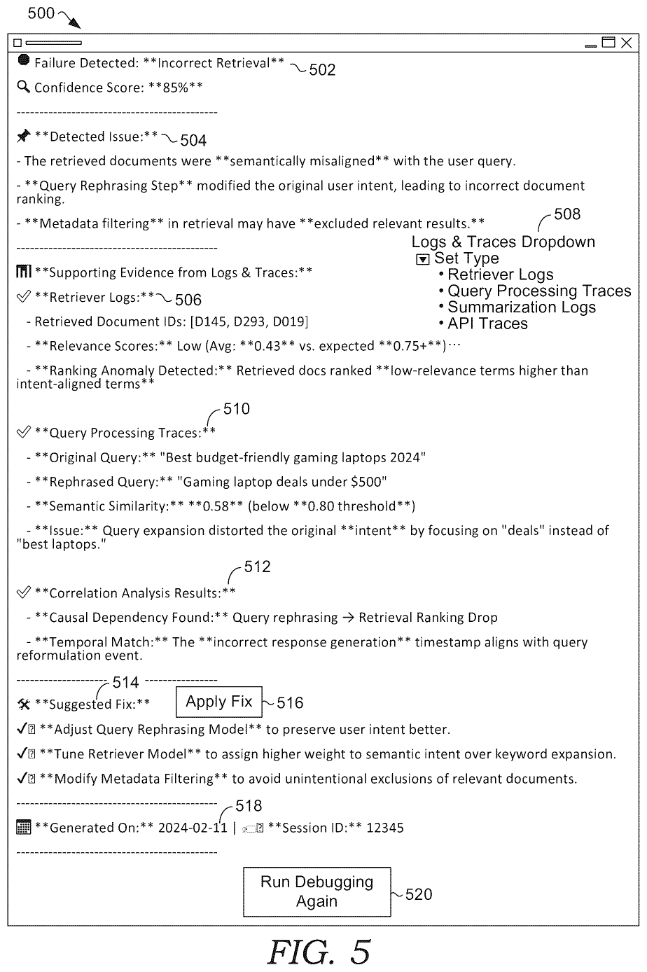

FIG. 5 represents of a screenshot of an example user interface page 500 illustrating an interactive root cause report, according to some embodiments. In some embodiments, for example, the user interface page 500 represents the root cause report 420 of FIG. 4. The user interface page 502 includes a summary section 502, illustrating the particular issue detected (e.g., as classified by the feedback classification language model 132 of FIG. 1), along with a confidence score indicating the likelihood represents the likelihood (in percentage) that the feedback classifier correctly identified the predetermined category of the failure, based on the system's historical patterns, semantic similarity analysis, and/or log-trace correlations.

Section 504 of the user interface page 500 represents the detected issue and/or stage in the data processing pipeline (e.g., as determined by the correlation engine 418 of FIG. 4). For example, the correlation engine 418 may map the predetermined category to particular data processing stage by analyzing application logs and application traces, as described herein. Section 506 provides support from retriever logs that supports the incorrect retrieval issue classification. The retrieved document IDs (D145, D293, D019) represent the actual documents (search results) returned by the retrieval system. However, their relevance scores (average 0.43, which is significantly lower than the expected 0.75+) indicate that the documents were poorly ranked in terms of relevance to the user query. The ranking anomaly detection further highlights that the retrieval model prioritized documents containing low-relevance terms over those that matched the user's intent, suggesting a potential issue with query reformulation, ranking weights, or metadata filtering. Drop down menu 508 allows users to filter logs/traces dynamically based on the issue type. This makes it easier to analyze relevant debugging data without being overwhelmed by unnecessary information. For example, if the category is “Incorrect Retrieval,” the dropdown lets users select only Retriever Logs and Query Processing Traces to inspect issues related to ranking scores, document mismatches, or query reformulation errors. If the issue were instead an “=” API Failure,” users could filter for API Logs and API Traces to investigate timeout errors, response delays, or missing external data. This functionality enhances debugging efficiency by providing a targeted, failure-specific log view.

Section 510 of the user interface page 500 highlights how query processing traces reveal a misalignment between the original user query and the rephrased query generated by the system. The original query, “Best budget-friendly gaming laptops 2024,” suggests the user is looking for a curated list of high-quality, affordable gaming laptops. However, the rephrased query, “Gaming laptop deals under $500,” shifts the focus toward finding sales or discounts rather than evaluating laptops based on quality and affordability. The semantic similarity score of 0.58 (e.g., below the 0.80 threshold) quantitatively confirms that the reformulated query deviates significantly from the original intent. This issue likely caused the retriever to return irrelevant documents focusing on pricing rather than performance, leading to incorrect retrieval and downstream summarization errors.

Section 512 provides a technical breakdown of why the issue occurred, using log-trace correlation analysis. It identifies causal relationships (e.g., Query rephrasing→Retrieval Ranking Drop) and temporally aligns issue events with system logs (e.g., Incorrect response timestamp matches the query reformulation event). This part is generated after the correlation engine 418 has cross-referenced logs and traces to confirm the actual cause of issue rather than just symptoms.

Section 514 provides actionable recommendations derived from the correlation engine's analysis to correct the detected failure. The first fix, “Adjust Query Rephrasing Model,” involves fine-tuning the query reformulation LLM or retrieval preprocessor to ensure semantic preservation, preventing unintended changes in meaning. The second fix, “tune Retriever Model,” leads to modifying retrieval ranking functions to prioritize semantic intent over keyword-based matching, which may occur by adjusting ranking weights, modifying embedding similarity thresholds, or retraining the retriever with improved labeled data. Lastly, the “Modify Metadata Filtering” step focuses on revising filtering criteria applied during retrieval, ensuring that documents are not mistakenly excluded due to overly restrictive metadata constraints (e.g., filtering out results that lacked explicit price tags in a budget laptop query). These fixes can be applied automatically through system parameter updates or manually adjusted by engineers based on debugging insights and/or selecting the “apply fix” button 516.

With respect to section 518, the “Generated On” field records the timestamp when the root cause report was generated, helping engineers track when the issue was analyzed in relation to system logs and traces. The “Session ID” is a unique identifier assigned to the specific user interaction or query session, allowing the system to retrieve relevant logs, traces, and processing history associated with the detected failure. Together, these fields ensure that debugging efforts remain session-specific and reproducible for further analysis or verification. The “run debugging again” button 520 allows engineers to run a second or subsequent debugging rounds after, for example, the “suggested fix” has been applied, and/or the user selects the particular logs and traces via the dropdown in 508.

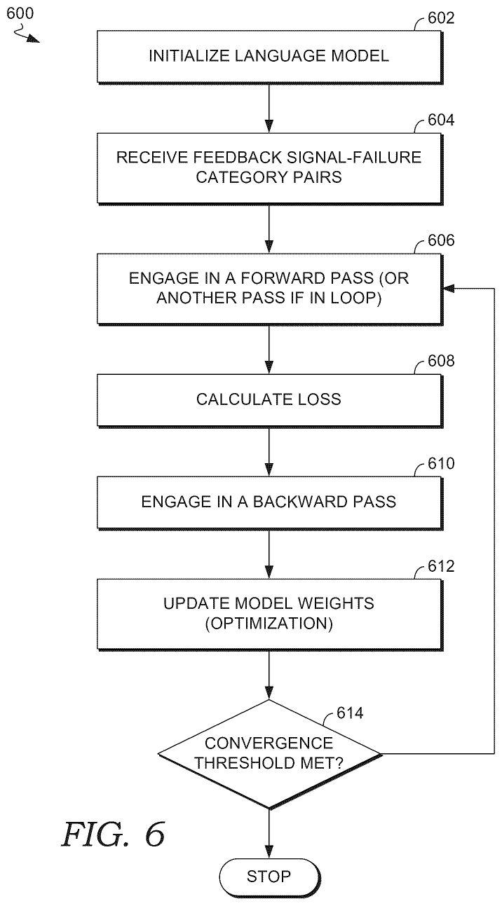

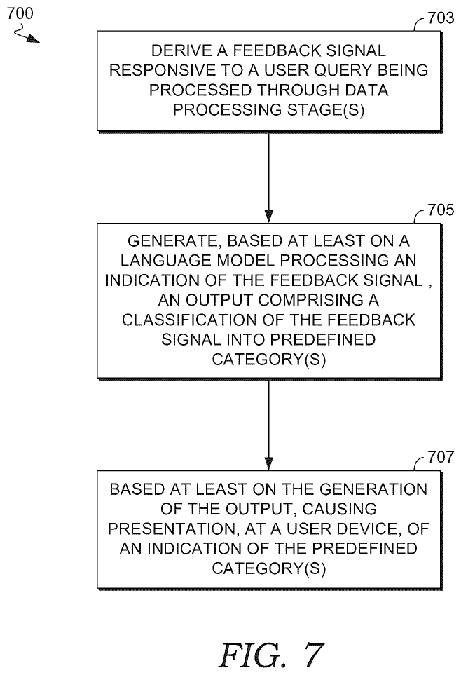

Now referring to FIGS. 6 and 7, each block of processes 600 and 700 described herein, comprises a computing process that may be performed using any combination of hardware, firmware, and/or software. For instance, various functions may be carried out by a processor executing instructions stored in memory, dedicated AI hardware accelerator circuitry, or the like. The processes may also be embodied as computer-usable instructions stored on computer storage media. The methods may be provided by a standalone application, a service or hosted service (standalone or in combination with another hosted service), or a plug-in to another product, to name a few. In addition, the processes 600 and 700 are described, by way of example, with respect to the system 100 of FIG. 1. However, these processes may additionally or alternatively be executed by any one system, or any combination of systems, including, but not limited to, those described herein.

FIG. 6 is a flow diagram of an example process 600 for tuning (e.g., train by prompt-tuning or fine-tuning) a language model to categorize a feedback signal into a category, according to some embodiments. Prompt-tuning and fine-tuning are techniques used to adapt a language model to generate specific outputs (feedback categories) based on particular inputs. This training approach involves using supervised learning techniques with input-output pairs, where the input represents specific (e.g., feedback signals, logs, and/or traces), and the output represents a given predetermined category. The model learns from these examples using gradient-based optimization, and the training loop iterates until convergence is achieved.

Per block 602, some embodiments initialize a language model. For instance, some embodiments load a pre-trained language model (e.g., BERT, T5, GPT) and prepare it for classification fine-tuning by selecting a pre-trained transformer-based model (e.g., RoBERTa, GPT, T5), define classification head (e.g., softmax layer for multi-class classification), initialize model parameters (random weights if training from scratch), and set hyperparameters (e.g., learning rate, batch size, optimizer).

Per block 604, some embodiments receive multiple feedback signal—issue category pairs, which represents the training data. In other words, a dataset of input-output pairs are generated where the input represents different feedback signals (e.g., explicit user feedback, implicit user engagement signals, and/or system-generated feedback). The output of the pairs represents the expected output for each input, which is a correct predetermined category (e.g., incorrect rephrasing, irrelevance, incorrect reranking of retrieved passages, incorrect or irrelevant citations, and latency) that the input belongs to, In other words, the goal is to structure the dataset to map feedback signals to predefined categories. For example, feedback Signals (Input) can include the following: “The chatbot gave an irrelevant answer.” “It took too long to respond.” And “The API call failed.” The corresponding and respective feedback category (Output) may include the following: “Incorrect Retrieval” “Latency Issue” and “API Failure.”

Some embodiments load the labeled dataset of (Feedback Signal→Issue Category) pairs, tokenize feedback signals into embeddings, augment dataset with synthetic issue cases (if needed), and/or incorporate application logs/traces as additional context, such as logs/traces representing the input and predetermined categories as the output. For example, a log context from a log entry can include “Query expansion altered the original intent” and the final labeled category can be “Incorrect Retrieval.”

Per block 606, some embodiments engage in a forward pass (or another pass if in loop (e.g., a “no” decision at block 614)). For each feedback signal—issue category pair, some embodiments feed the input (feedback signal) into the language model agent. The agent processes the input and generates an initial output, which is a candidate predetermined category. The goal is to generate a first version of category that indicates the issue type associated with the feedback signal. For example, an LLM first encodes feedback signals. The LLM then passes the embeddings through the classification head (softmax layer) in order to obtain probability scores for each predefined category. For example, model output probabilities may include the following: “Incorrect Retrieval”: 85% “Incorrect Summarization”: 10% “Latency Issue”: 5%, where the predicted category is “Incorrect Retrieval“ based on the confidence being highest for Incorrect Retrieval.

In other words for block 606, during the forward pass, the LLM encodes the input feedback signal into a high-dimensional embedding vector that captures its semantic meaning. This embedding is then passed through a classification head, which may include a fully connected (linear) layer followed by a softmax activation function. The linear layer maps the LLM-generated embedding to a fixed-size output vector, where each dimension corresponds to one of the predefined categories (e.g., Incorrect Retrieval, Incorrect Summarization, Latency Issue, API Failure). The softmax function then normalizes these outputs into probability scores by converting the raw logits into a probability distribution summing to 1. For example, if the softmax output is [0.85, 0.10, 0.05, 0.00], the system predicts “Incorrect Retrieval” with 85% confidence. This final probability distribution is used for classification and confidence-based thresholding in issue attribution.

Per block 608, some embodiments calculate a loss using a loss function. This measures how different the model's predictions are from ground truth labels (feedback signal-issue category pairs). For example, some embodiments calculate Categorical Cross-Entropy Loss for language tasks. The categorical cross-entropy loss measures how well the predicted probability distribution aligns with the true category in a multi-class classification task. It calculates the logarithmic difference between the model's predicted probabilities and the one-hot encoded ground truth label, penalizing incorrect predictions more heavily. In this case, if the true category is “Incorrect Retrieval” (encoded as [1,0,0,0]) and the model predicts [0.85, 0.10, 0.05, 0.00], the loss function computes −log(0.85)≈0.16, indicating a low error. A higher loss would indicate greater misclassification, guiding the model's backpropagation step to adjust weights and improve future predictions.

Per block 610, some embodiments engage in a backward pass (e.g., via Gradient Descent). In other words, various embodiments perform a backward pass through the language model to calculate the gradients of the loss with respect to the model's parameters. This involves computing the gradients for each layer of the model based on the error (loss) calculated at bock 608. The goal is to determine how the model's weights should be updated to reduce the error in future iterations. Gradients help the model understand how much to adjust its parameters (weights) in order to generate better outputs in the next iteration.

Per block 612, some embodiments update model weights for optimization. To do this, some embodiments apply an optimization algorithm (optimizer), such as Stochastic Gradient Descent (SGD) or Adam, to update the model's weights based on the gradients calculated at block 610 and adjust learning rate if needed (e.g., use learning rate decay). The goal is to iteratively improve the model's ability to classify feedback signals into correct predetermined categories by reducing the loss over time. The optimizer adjusts the model parameters slightly with each iteration, aiming to minimize the overall loss and make the model's predictions closer to the target outputs.

Per block 614, some embodiments determine whether a convergence threshold has been met. Various embodiments stop the training process 600 when a convergence threshold is reached, either based on a predefined convergence threshold (e.g., when the loss falls below a certain value) and/or after a set number of iterations (epochs). The goal is to end training when the language model agent consistently generates accurate prompts that align with the expected outputs. For example, example conditions may include “If Validation Loss≤0.05→Stop Training; If Accuracy reaches 95%→Stop Training; Else→Continue Training.

If the convergence threshold has not been met (e.g., a “no” decision at block 614), then particular embodiments engage in blocks 606 (e.g., another pass), 608, 610, 612, and 614 (and/or new feedback signal-issue category pairs are received at block 604). In other words, these steps are repeated for multiple input-output pairs in the training dataset. The language model iteratively processes inputs, computes loss, updates its weights, and refines its outputs over time. The goal is to iteratively improve the model's performance, minimizing the loss with each step and making the language model more effective at classifying feedback signals based on the feedback signals. The training loop continues until the model reaches a satisfactory level of performance. After training, some embodiments evaluate the language model agent on a separate test set that includes unseen input-output pairs. The goal is to verify that the model can generalize to new data. This step ensures that the language model performs well in real-world scenarios, not just on the training data.

FIG. 7 is a flow diagram of an example process 700 for generating an output that includes a classification of a feedback signal into one or more predefined categories, according to some embodiments. Per block 703, some embodiments derive a feedback signal responsive to a user query being processed through one or more data processing stages. A “data processing stage” is a distinct computational step within a pipeline that transforms, retrieves, ranks, and/or generates data, contributing to the overall processing of a user query. For example, any of the numbered operations described in FIG. 1, FIG. 2, or FIG. 3 represents a particular data processing stage.

A “feedback signal” as described herein refers to any implicit or explicit data point representing at least one of a quality, relevance, or performance of the least one pipeline stage, indicating whether the system output meets expected behavior. For example, the feedback signal can include explicit user feedback (e.g., thumbs up/down, corrective input), an implicit user behavior signal (e.g., query reformulation, response abandonment, latency sensitivity), or system-generated performance metrics (e.g., model confidence scores, retrieval ranking scores, API failure logs). Feedback signals serve as inputs to the feedback classification model, enabling automated issue attribution and root cause analysis across pipeline stages.

To derive the feedback signal at block 703, some embodiments monitor a plurality of data processing pipeline stages for the feedback signal by continuously logging execution data, tracking system performance metrics, and/or analyzing user interactions at each stage. As a user query propagates through stages such as query processing, retrieval, ranking, summarization, and response generation, the system collects explicit user feedback (e.g., thumbs up/down, corrections), implicit behavior signals (e.g., query reformulation, session abandonment), and system-generated metrics (e.g., retrieval ranking scores, LLM confidence scores, API latency measurements). These signals are timestamped and associated with the relevant pipeline stage, enabling real-time issue detection and root cause attribution. In some embodiments, the correlation engine then cross-references these feedback signals with application logs and traces, applying temporal alignment, semantic analysis, and anomaly detection to identify which stage is responsible for degraded performance or incorrect responses.

Responsive to a user query being processed through one or more data processing stages, explicit feedback can be captured at the end of the pipeline when a user directly interacts with the system's output. After retrieval, ranking, summarization, or response generation, the user may provide a thumbs up/down, correction input, or select an alternative response. This feedback is logged with session metadata (e.g., Query ID, Pipeline Stage, Timestamp), enabling attribution to a specific processing stage. The system then records and classifies this feedback as a structured event, triggering reprocessing or adaptation in future query handling.

Implicit feedback signals are derived passively as the system observes how the user interacts with the response. If a user rephrases the query after receiving an answer, the system detects that retrieval or ranking may have failed. Similarly, if a user abandons the session without interacting further, it may indicate low-quality summarization or incorrect response generation. These behaviors are detected via interaction logs and event tracking, mapped against processing timestamps, and correlated using anomaly detection models to attributes issue(s) to one or more pipeline stages. This means that user behavior events (e.g., query reformulation, session abandonment) are logged and timestamped to track when and how users interact with the system. These logs are then analyzed using anomaly detection models, which compare patterns of behavior against historical data to determine if an issue likely occurred at a specific pipeline stage (e.g., retrieval, summarization). If a user repeatedly reformulates their query after retrieval, the system correlates this event with logs and infers that the retrieval stage likely caused the issue.

As the query propagates through one or more data processing stages, system performance metrics are continuously logged. If the retrieval ranking scores are low, or the LLM confidence score drops below a threshold, the system autonomously flags a potential issue. Additionally, if an API request exceeds expected latency, or log traces reveal frequent query reformulations, the system identifies this as a performance degradation event. These metrics are collected in real time, fed into observability tools, and used in correlation analysis to detect failures and improve pipeline performance.

Per block 705, some embodiments generate, via at least on a language model processing an indication of the feedback signal, an output comprising a classification of the feedback signal into one or more predefined categories. A “language model” is a computational model trained or used to understand, generate, and/or predict text based on patterns in natural language. It assigns probabilities to sequences of words and can be used for tasks like text generation, retrieval-augmented generation (RAG), and semantic understanding. Examples of language models include LLMs, Small Language Models (SLM), RAG models, task-specific models (e.g., T5 (text-to-text), BERT (sentence classification), RoBERTa (NLP tasks)). It is understood, however, that the feedback classifier as described herein does not necessarily need to be a language model. Rather, other machine learning models can be used for feedback classification based on structured and unstructured data, such as Support Vector Machines (SVMs), Random Forest Classifier, Gradient Boosting Models (e.g., XGBoost, LightGBM, CatBoost), Multilayer Perceptron (MLP)/Feedforward Neural Networks, Convolutional Neural Networks (CNNs) for Text Classification, Recurrent Neural Networks (RNNs)/LSTMs for Sequential Data, and/pro Bayesian Classifiers (e.g., Naïve Bayes).

In an illustration of block 705, when a language model processes an indication of the feedback signal, it first tokenizes and encodes the input text (e.g., explicit user feedback, implicit behavior indicators, or system-generated metrics) into a dense vector representation. This representation is then passed through the model's attention layers, where it contextualizes the input based on patterns learned during pretraining and/or fine-tuning. The model then maps the encoded representation to predefined categories representing one or more issue types (e.g., Incorrect Retrieval, Latency Issue, API Failure) using a classification head, such as a fully connected layer with a softmax activation function. The softmax layer outputs probability scores for each category, allowing the system to select the category with the highest confidence score (e.g., “Incorrect Retrieval” with 85% confidence). This output is then logged for debugging or fed into the Correlation Engine to perform further root cause analysis.

In some embodiments, a “predefined category” refers or corresponds to any issue category, such as at least one of an inefficiency type, an anomaly type, or a failure type at a respective data processing pipeline stage. An “inefficiency” refers to a suboptimal process that degrades system performance but does not outright break functionality. For example, in a retrieval-augmented generation (RAG) pipeline, the retriever might return a large set of documents, many of which are irrelevant, causing increased computational overhead and longer response times. While the system still provides an answer, it does so with higher latency and unnecessary resource consumption. This inefficiency could be addressed by optimizing ranking heuristics to reduce unneeded retrieval steps and improve response time without sacrificing accuracy. Specific examples of inefficiency types include the following retrieval latency overhead (excessive document fetching slows down response time), redundant query reformulation (unnecessary rewording of queries increases processing time), overloaded summarization processing (too many retrieved documents cause inefficient summarization) inefficient API call handling (unoptimized API request batching results in higher latency), excessive vector search computation (vector retrieval searches too large an index, consuming unnecessary resources).

An “anomaly” refers to an unexpected deviation from normal system behavior, even if it does not immediately result in failure. Suppose a chatbot is designed to rephrase user queries for better document retrieval. If a user asks, “What are the best high-performance laptops for gaming? and the query rephrasing step unexpectedly changes it to, “Cheap laptop deals under $300,” the system has introduced an unusual transformation that alters the user's intent. This query shift may be flagged as an anomaly in the query reformulation stage, as it significantly deviates from historical query processing patterns. A specific example of such named predefined category is “Query Rewriting Intent Shift.” Examples of anomaly types/categories include the following: query rewriting intent shift (reformulated query significantly deviates from user intent), ranking skew detection (retrieval model ranks irrelevant documents higher than relevant ones), semantic similarity drop (retrieved passages have unusually low relevance scores), unexpected response truncation (e.g., an LLM-generated answer gets unexpectedly cut off), and log pattern anomaly (pipeline execution logs show unusual event sequences).

A “failure” refers to a complete breakdown in functionality, preventing a system component from operating as expected. For example, if the pipeline calls an external API for real-time stock prices and the API request times out, the system may return a generic error message or an incomplete response. Unlike an inefficiency or anomaly, this failure directly disrupts the pipeline's ability to generate a valid answer. In this case, logs and traces would capture API timeout errors, allowing the system to classify the issue under the “API Failure” category and trigger a fallback mechanism or retry logic. Examples of failure types/categories include the following: API call timeout (external API fails to return data within the required timeframe), zero document retrieval (retrieval model fails to return any relevant documents), execution Failure in query processing (query parsing encounters a fatal error), model output generation error (e.g., an LLM fails to generate a valid response due to internal constraints or guardrails), or critical pipeline breakdown (dependency failure halts the entire pipeline execution).

There may be any suitable quantity and type of predefined categories. For example, the predefined categories may include incorrect rephrasing, irrelevance, incorrect re-ranking of retrieved passages, incorrect or irrelevant citations, and latency. “Incorrect Rephrasing” captures cases where the query rephrasing step alters the original user intent, leading to downstream retrieval or ranking issues. For example, if a user asks, “What are the best high-performance laptops?” and the system rephrases it as “Find laptop deals under $500,” the intent shifts from quality-based evaluation to pricing, potentially returning irrelevant results.

The “irrelevance” category refers to situations where the retrieved passages, summaries, or final responses do not match the user's information need. For example, a user searching for “symptoms of Vitamin D deficiency” might receive passages discussing “general benefits of vitamins” instead, indicating that retrieval or summarization failed to align with the query intent. The “incorrect Re-Ranking of Retrieved Passages” occurs when the ranking model prioritizes less relevant or lower-quality documents over more relevant ones. For instance, if a retrieval model fetches a set of relevant documents but the ranking stage places low-relevance documents at the top, the user might see outdated or tangentially related information first, even though a better answer exists further down in the list.

The “incorrect or Irrelevant Citations” issue category applies when the system generates citations that do not support the stated information or when cited sources are not contextually relevant. For example, if an LLM-generated response claims “The human body requires 2,500 mg of Vitamin C daily (Source: WHO),” but the cited WHO document never states this, the citation is considered incorrect or fabricated (hallucination). The “latency” category accounts for response time delays that degrade user experience, often caused by slow API calls, inefficient retrieval, or excessive computational overhead. For example, if a chatbot query that typically returns an answer in 1 second suddenly takes 10 seconds, the system may classify this as a latency issue, identifying the bottlenecked stage (e.g., slow document retrieval, excessive vector search computation, or API rate-limiting).

Some embodiments map, attribute, associate the one or more predefined categories to the one or more data processing pipeline stages of the plurality of processing pipeline stages via any suitable manner. Mapping or associating the one or more predefined categories to the one or more data processing pipeline stages means establishing a structured relationship (e.g., via a lookup table, rule-based system, or model-driven correlation) between classified inefficiencies, anomalies, or failures and the specific stages in the pipeline where they most likely originated, enabling automated issue attribution and targeted debugging. For example, a dictionary-style data structure can be implemented as follows:
{
   “Incorrect Rephrasing”: “Query Processing Stage”,
   “Irrelevance”: “Retrieval Stage”,
   “Incorrect Re-Ranking of Retrieved Passages”: “Ranking Stage”,
   “Incorrect or Irrelevant Citations”: “Summarization Stage”,
   “Latency”: “API Integration Stage”
}

When the feedback classifier, for example, categorizes a feedback signal, it assigns it a predefined issue category. The system looks up the predefined category in the mapping structure, instantly retrieving the corresponding pipeline stage. The correlation engine additionally or alternatively validates this mapping using logs and traces to confirm that the issue actually originated at the mapped stage. The issue attribution system flags the affected stage for debugging or pipeline optimization. Additionally or alternatively, such mapping, attributing, or associating occurs via correlational analysis, such as described with respect to the correlation engine 418 of FIG. 4. When a feedback signal is classified into a predefined category (e.g., Incorrect Retrieval, Latency Issue, Query Rewriting Intent Shift), for example, the system correlates the issue type with logged events at different stages of the pipeline. Using temporal alignment, for example, the system identifies when the issue occurred relative to query processing, retrieval, ranking, summarization, or response generation. Accordingly, based at least on the detecting of the specific condition and the classification of the feedback signal, some embodiments attribute the one or more predefined categories to a respective data processing stage, of a plurality of data processing pipeline stages. In this way, the attribution indicates which data processing stage is most likely contains or is responsible for the issue type.

In some embodiments, the generating the output at block 705 further comprises generating a confidence score associated with the classification, the confidence score representing a likelihood that the feedback signal corresponds to the respective predefined category. Examples of this are described with respect to the confidence scores for each of the feedback classifier 402's predictions—75%, 10%, 5%, and 5%.

In some embodiments, responsive to the generating of the output comprising the classification of the feedback signal at block 705, some embodiments detect at least a specific condition associated with the failure, anomaly, or inefficiency by analyzing at least one of application logs or application traces. For example, responsive to the user query being processed through at least one data processing pipeline stage, some embodiments cause at least one of application logs or application traces to record associated data. And responsive to the language model generating the output comprising the classification of the feedback signal, some embodiments detect one or more specific conditions that led to the failure, anomaly, or inefficiency at the respective data processing pipeline stage using one or more correlation techniques on at least a portion of the application logs or application traces.

A “condition” in this context refers to a specific system state, event, or deviation detected in logs, traces, or model outputs that contributes to or triggers a failure, anomaly, or inefficiency (corresponding to the predefined category) at a respective data processing pipeline stage. In an illustrative example, a condition may be “Low semantic similarity (0.45 instead of 0.80+) between the original query and retrieved documents,” whereas a predefined category may more generically be “Incorrect Retrieval (retrieved documents did not match user intent)” In some embodiments, these conditions are identified using any suitable machine learning model and/or correlation techniques (e.g., temporal correlation, semantic log analysis, causal dependency tracing) to pinpoint root causes rather than just symptoms, as described, for example, with respect to the correlation engine 418 of FIG. 4. For example, a retrieval system is expected to return documents relevant to the user query, but the retriever logs show a low semantic similarity score (e.g., 0.45 instead of 0.80+). The query processing traces indicate that query rephrasing shifted the original intent, causing retrieval to fetch incorrectly ranked documents. Using temporal and semantic correlation analysis, the system detects that this deviation in query reformulation timing and semantic similarity score caused the incorrect retrieval failure, making “low semantic similarity due to query misalignment” a condition leading to the failure.

Some embodiments retrieve a portion of at least one of the application logs or application traces comprises to do this analysis. This may include searching indexed log records using at least one of a session identifier, query identifier, timestamp, or pipeline stage metadata. When the system detects a failure, inefficiency, or anomaly at a specific data processing pipeline stage, it retrieves the relevant application logs or traces by searching indexed log records using identifiers such as session ID, query ID, timestamp, and/or pipeline stage metadata. This process enables targeted retrieval of log entries related to the specific issue, rather than scanning the entire log database. For example, if a feedback classifier labels an issue as “Incorrect Retrieval,” the system looks up retrieval-stage logs using the query ID associated with the user session, filtering for retrieved document rankings, metadata filters, and semantic similarity scores. If logs indicate a retrieval ranking anomaly at timestamp T1, the system retrieves query processing traces around T1 to determine if query rephrasing contributed to the misalignment, allowing the correlation engine to pinpoint the root cause efficiently.

Per block 707, based at least on the generation of the output, some embodiments cause presentation at a user device (e.g., a mobile device, smart watch, smart speaker, or desktop device), of an indication of the one or more predefined categories. For example, such indication may include any of the data as illustrated in the screenshot of the user interface page 500 of FIG. 5. Additionally or alternatively, some embodiments trigger a response such as generating a diagnostic report (e.g., the root cause report 420) and/or updating a pipeline configuration parameter. After detecting and classifying a failure, inefficiency, or anomaly at a specific pipeline stage, the system triggers a response to mitigate the issue or inform developers. This can involve generating a diagnostic report that summarizes the detected issue, root cause analysis, and suggested fixes, which is then stored in a feedback data lake for trend analysis. Alternatively, the system can update a pipeline configuration parameter—such as adjusting ranking weights, changing query rephrasing rules, or modifying API timeout thresholds—to dynamically optimize performance. Lastly, the system may present an indication of the issue at a user interface, such as in a debugging dashboard or root cause report, showing confidence scores, affected pipeline stages, and recommended actions to guide engineers in resolving the issue. These automated responses ensure continuous pipeline optimization and reduce manual debugging efforts.

In some embodiments, causing presentation at the user device includes presenting, within a diagnostic user interface (e.g., the user interface 500 of FIG. 5), of at least one of the respective data processing pipeline stage (e.g., the “query rephrasing step” language in 504), the classified predefined category (e.g., the “incorrect retrieval” language in 502), and/or a suggested corrective action (e.g., the suggested fix 514).

In some embodiments, the systems and methods described herein may be performed within (or used to programmatically build) a simulation environment (e.g., NVIDIA's DriveSIM) using simulated data (e.g., simulated sensor data of simulated sensors of a virtual or simulated machine). For example, if a simulated autonomous vehicle misclassifies a pedestrian as a cyclist, the system can classify this as an Incorrect Perception Category, retrieve sensor processing logs and simulation traces, and correlate the failure to an anomaly in the object recognition model, suggesting adjustments in the perception module's training data. This information may be used to perform operations associated with the virtual machine within the environment. These simulated operations may be used to test performance of the underlying algorithms, code, systems, and/or processes prior to deploying them in the real-world. In some instances, the simulation may be used to generate synthetic training data. The synthetic training data (in addition to or alternatively from real-world data) may then be processed to determine geometry and/or other information related to regions of interest. In any example, such as where a simulation environment is used for testing, validation, training, etc., the simulation environment and/or associated training data may be rendered or otherwise generated using data processing pipelines that indicates one or more light transport algorithms-such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some embodiments, the system and methods described herein may be deployed in a talking or smart kiosk application. For example, some embodiments can enhance conversational AI performance by detecting intent misinterpretation, incorrect response generation, or latency issues. If a user query is repeatedly rephrased or abandoned, the system classifies this as an Incorrect Rephrasing or Irrelevance Category, then analyzes query processing logs and LLM response traces to identify conditions such as semantic drift or intent ambiguity, enabling fine-tuning of the intent detection model to improve user engagement. A kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

In one or more embodiments, the system and methods described herein may be deployed in a gaming application. In GeFORCE NOW or other gaming applications, for example, some embodiments detect and classify performance issues, input lag, or rendering artifacts that affect user experience. For instance, if a player reports delayed input response, the system classifies this as a Latency Issue Category, retrieves network latency logs, GPU processing traces, and uses temporal correlation to identify high frame rendering times as the root cause. It then suggests optimizing GPU resource allocation or network buffering mechanisms to reduce input lag. A gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, n one or more embodiments, the system may enable users to interact with the video conferencing platform using natural language inputs representing a user query. Users may issue voice commands to schedule, join, or leave meetings, or to manage participants and screen sharing, which are then processed in various data processing pipelines and particular embodiments attribute specific issues to particular stages. During receiving and/or sending the data to and from the end-user or edge device(s), one or more data processing units (DPUs) and/or network interface cards (NICs) may be used. A video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction.

In some embodiments, the system and methods described herein may be deployed in a robotics application. In robotics applications, for example, some embodiments improve perception, navigation, and task execution by classifying feedback related to sensor inaccuracies, control delays, or incorrect decision-making. For example, if a robot incorrectly identifies an obstacle, the system classifies it as an Incorrect Perception Category, retrieves sensor fusion logs and decision-making traces, and correlates low-confidence object detection events with the failure. It then suggests retraining perception models or adjusting sensor calibration parameters for more reliable navigation. A robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, some embodiments enhance user interaction by classifying feedback on voice recognition accuracy, UI responsiveness, or content recommendations. If users repeatedly rephrase voice commands, it is classified as an Incorrect Intent Detection Category. By analyzing voice processing logs, intent classification traces, and latency measurements, the system correlates phonetic ambiguity or slow response generation to the issue. It then recommends updating voice models or optimizing UI workflows for a more intuitive user experience. The infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), etc.), and/or other types of machine learning models.

In some embodiments, one or more transformer engines (TEs) may be implemented. The transformer engine may use micro-tensor scaling to optimize performance and accuracy—such as to enable 16-bit floating point (FP16), 8-bit floting point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink Switches) and tensor cores (which enable mixed-precision computing, such as microscaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 8A is a block diagram of an example generative language model system 800 suitable for use in implementing at least some embodiments of the present disclosure. In the example illustrated in FIG. 8A, the generative language model system 800 includes a retrieval augmented generation (RAG) component 892, an input processor 805, a tokenizer 810, an embedding component 820, plug-ins/APIs 895, and a generative language model (LM) 830 (which may include an LLM, a VLM, a multi-modal LM, etc.).

At a high level, the input processor 805 may receive an input 801 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 830 (e.g., LLM/VLM/MMLM/etc.). In some embodiments, the input 801 includes plain text in the form of one or more sentences, paragraphs, and/or documents. Additionally or alternatively, the input 801 may include numerical sequences, precomputed embeddings (e.g., word or sentence embeddings), and/or structured data (e.g., in tabular formats, JSON, or XML). In some implementations in which the generative LM 830 is capable of processing multi-modal inputs, the input 801 may combine text (or may omit text) with image data, audio data, video data, design data, USD data, and/or other types of input data, such as but not limited to those described herein. Taking raw input text as an example, the input processor 805 may prepare raw input text in various ways. For example, the input processor 805 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 805 may remove stopwords to reduce noise and focus the generative LM 830 on more meaningful content. The input processor 805 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 892 (which may include one or more RAG models, and/or may be performed using the generative LM 830 itself) may be used to retrieve additional information to be used as part of the input 801 or prompt. RAG may be used to enhance the input to the LLM/VLM/MMLM/etc. with external knowledge, so that answers to specific questions or queries or requests are more relevant—such as in a case where specific knowledge is required. The RAG component 892 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 801 may be generated using the query or input to the model (e.g., a question, a request, etc.) in addition to data retrieved using the RAG component 892. In some embodiments, the input processor 805 may analyze the input 801 and communicate with the RAG component 892 (or the RAG component 892 may be part of the input processor 805, in embodiments) in order to identify relevant text and/or other data to provide to the generative LM 830 as additional context or sources of information from which to identify the response, answer, or output 890, generally. For example, where the input indicates that the user is interested in a desired tire pressure for a particular make and model of vehicle, the RAG component 892 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 892 may retrieve a prior stored conversation history—or at least a summary thereof—and include the prior conversation history along with the current ask/request as part of the input 801 to the generative LM 830.

The RAG component 892 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 892 and the embeddings of the chunks along with the embeddings of the query may be compared to identify the most similar/related embeddings to the query, which may be supplied to the generative LM 830 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 892 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 810 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 830 to understand morphological variations and handle out-of-vocabulary words more effectively. Character-based tokenization represents each character as a separate token, enabling the generative LM 830 to process text at a fine-grained level. The choice of tokenization strategy may depend on factors such as the language being processed, the task at hand, and/or characteristics of the training dataset. As such, the tokenizer 810 may convert the (e.g., processed) text into a structured format according to tokenization schema being implemented in the particular embodiment.

The embedding component 820 may use any known embedding technique to transform discrete tokens into (e.g., dense, continuous vector) representations of semantic meaning. For example, the embedding component 820 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 801 includes image data/video data/etc., the input processor 801 may resize the data to a standard size compatible with format of a corresponding input channel and/or may normalize pixel values to a common range (e.g., 0 to 1) to ensure a consistent representation, and the embedding component 820 may encode the image data using any known technique (e.g., using one or more convolutional neural networks (CNNs) to extract visual features). In some implementations in which the input 801 includes audio data, the input processor 801 may resample an audio file to a consistent sampling rate for uniform processing, and the embedding component 820 may use any known technique to extract and encode audio features—such as in the form of a spectrogram (e.g., a mel-spectrogram). In some implementations in which the input 801 includes video data, the input processor 801 may extract frames or apply resizing to extracted frames, and the embedding component 820 may extract features such as optical flow embeddings or video embeddings and/or may encode temporal information or sequences of frames. In some implementations in which the input 801 includes multi-modal data, the embedding component 820 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 830 and/or other components of the generative LM system 800 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 820 may apply an encoded representation of the input 801 to the generative LM 830, and the generative LM 830 may process the encoded representation of the input 801 to generate an output 890, which may include responsive text and/or other types of data.

As described herein, in some embodiments, the generative LM 830 may be configured to access or use—or capable of accessing or using—plug-ins/APIs 895 (which may include one or more plug-ins, application programming interfaces (APIs), databases, data stores, repositories, etc.). For example, for certain tasks or operations that the generative LM 830 is not ideally suited for, the model may have instructions (e.g., as a result of training, and/or based on instructions in a given prompt, such as those retrieved using the RAG component 892) to access one or more plug-ins/APIs 895 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 895 to the plug-in/API 895, the plug-in/API 895 may process the information and return an answer to the generative LM 830, and the generative LM 830 may use the response to generate the output 890. This process may be repeated—e.g., recursively—for any number of iterations and using any number of plug-ins/APIs 895 until an output 890 that addresses each ask/question/request/process/operation/etc. from the input 801 can be generated. As such, the model(s) may not only rely on its own knowledge from training on a large dataset(s) and/or from data retrieved using the RAG component 892, but also on the expertise or optimized nature of one or more external resources—such as the plug-ins/APIs 895.

FIG. 8B is a block diagram of an example implementation in which the generative LM 830 includes a transformer encoder-decoder. For example, assume input text such as “Who discovered gravity” is tokenized (e.g., by the tokenizer810 of FIG. 8A) into tokens such as words, and each token is encoded (e.g., by the embedding component 820 of FIG. 98A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 835 of the generative LM 830.

In an example implementation, the encoder(s) 835 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 840 may convert the context vector into attention vectors (keys and values) for the decoder(s) 845.

In an example implementation, the decoder(s) 845 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 835, in an example transformer architecture, each token (e.g., word) flows through a separate path in the decoder(s) 845. During a first pass, the decoder(s) 845, a classifier 850, and a generation mechanism 855 may generate a first token, and the generation mechanism 855 may apply the generated token as an input during a second pass. The process may repeat in a loop, successively generating and adding tokens (e.g., words) to the output from the preceding pass and applying the token embeddings of the composite sequence with positional encodings as an input to the decoder(s) 845 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 835, except that it creates its queries from the layer below it and takes the keys and values (e.g., matrix) from the output of the encoder(s) 835.

As such, the decoder(s) 845 may output some decoded (e.g., vector) representation of the input being applied during a particular pass. The classifier 850 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 855 may select or sample a word or token based on a corresponding predicted probability (e.g., select the word with the highest predicted probability) and append it to the output from a previous pass, generating each word or token sequentially. The generation mechanism 855 may repeat the process, triggering successive decoder inputs and corresponding predictions until selecting or sampling a symbol or token that represents the end of the response, at which point, the generation mechanism 855 may output the generated response.

FIG. 8C is a block diagram of an example implementation in which the generative LM 830 includes a decoder-only transformer architecture. For example, the decoder(s) 860 of FIG. 8C may operate similarly as the decoder(s) 845 of FIG. 8B except each of the decoder(s) 860 of FIG. 8C omits the encoder-decoder self-attention layer (since there is no encoder in this implementation). As such, the decoder(s) 860 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 860. As with the decoder(s) 845 of FIG. 8B, each token (e.g., word) may flow through a separate path in the decoder(s) 860, and the decoder(s) 860, a classifier 865, and a generation mechanism 870 may use auto-regression to sequentially generate one token at a time until predicting a symbol or token that represents the end of the response. The classifier 865 and the generation mechanism 870 may operate similarly as the classifier 850 and the generation mechanism 855 of FIG. 8B, with the generation mechanism 870 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). As such, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that allow the computing device 900 to communicate with other computing devices via an electronic communication network, included wired and/or wireless communications. The communication interface 910 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may allow the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that allow detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to allow the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may use distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

One or more of the embodiments described below may be combined with one or more other embodiments or exist alone without any combining. In an example embodiment, one or more processors comprise processing circuitry to: derive a feedback signal responsive to a user query being processed through at least one data processing pipeline stage, of a plurality of data processing pipeline stages, the feedback signal representing at least one of a quality, relevance, or performance of the at least one pipeline stage; generate, based at least on a language model processing an indication of the feedback signal, an output comprising a classification of the feedback signal into one or more predefined categories, each predefined category corresponding to an issue type associated with the at least one pipeline stage; and based at least on the generation of the output, causing presentation, at a user device, of an indication of the one or more predefined categories.

In some embodiments, the feedback signal represents at least one of explicit user feedback, an implicit user behavior signal, or a system-generated performance metric, the system-generated performance metric comprising at least one of a model confidence score, retrieval ranking score, or latency measurement.

In some embodiments, he generating the output further comprises generating a confidence score associated with the classification, the confidence score representing a likelihood that the feedback signal corresponds to a respective predefined category.

In some embodiments, the processing circuitry is further to: responsive to the user query being processed through at least one data processing pipeline stage, causing at least one of application logs or application traces to record associated data; and responsive to the language model generating the output comprising the classification of the feedback signal, detect one or more specific conditions that led to an issue associated with the issue type using one or more correlation techniques on at least a portion of the application logs or application traces, the one or more correlation techniques comprising temporal correlation, semantic matching, or causal dependency analysis.

In some embodiments, the causing the presentation at the user device further comprises presenting, within a diagnostic user interface, at least one of the respective data processing pipeline stage, the classified predefined category, or a suggested corrective action.

In some embodiments, the processing circuitry is further to: train or prompt the language model by processing a plurality of example input-output pairs, each input-output pair comprising a respective feedback signal as an input and a corresponding predefined category as an output.

In some embodiments, the one or more predefined categories include at least one of Incorrect Rephrasing, Irrelevance, Incorrect Re-Ranking, Incorrect or Irrelevant Citations, or Latency.

In some embodiments, the processing circuitry is further to: responsive to the generating of the output comprising the classification of the feedback signal, detect at least a specific condition associated with the issue type by analyzing at least one of application logs or application traces; and based at least on the detecting of the specific condition and the classification of the feedback signal, attribute the one or more predefined categories to the at least one data processing pipeline stage, the attribution indicating which data processing stage is most likely responsible for the issue type.

In some embodiments, the one or more processors is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for implemented using one or more large language models (LLMs); a system for implemented using one or more vision language models (VLMs); a system implemented using one or more multi-modal language models (MMLMs); a system implemented using one or more inference microservices including one or more open-source level virtualization containers and one or more machine learning models; a system incorporating one or more virtual machines (VMs); a system implemented at least partially in a data center; or a system implemented at least partially using cloud computing resources.

In one embodiments, a system comprises one or more processors to: generate, based at least on a machine learning model processing an indication of a feedback signal, an output comprising a classification of the feedback signal into one or more predefined categories, each predefined category corresponding to at least one of a failure type, an anomaly type, or an inefficiency type; responsive to the generating of the output comprising the classification of the feedback signal, detect at least a specific condition associated with the failure type, anomaly type, or inefficiency type by analyzing at least one of application logs or application traces; based at least on the detecting of the specific condition and the classification of the feedback signal, attribute the one or more predefined categories to a respective data processing stage, of a plurality of data processing pipeline stages; and based at least in part on the attributing of the one or more predefined categories to the respective data processing stage, causing presentation, at a user device, of a at least one of, an indication of the specific condition, an indication of the one or more predefined categories, or an indication of the respective data processing stage.

In some embodiments, the feedback signal represents at least one of explicit user feedback, an implicit user behavior signal, or a system-generated performance metric, the system-generated performance metric comprising at least one of a model confidence score, retrieval ranking score, or latency measurement.

In some embodiments, the generating of the output further comprises generating a confidence score associated with the classification, the confidence score representing a likelihood that the feedback signal corresponds to a respective predefined category.

In some embodiments, the one or more processors are further to: responsive to a user query being processed through at least one data processing pipeline stage, causing at least one of the application logs or the application traces to record associated data; and responsive to the language model generating the output comprising the classification of the feedback signal, detect at least the specific condition that led to an issue using one or more correlation techniques on at least a portion of the application logs or application traces, the one or more correlation techniques comprising temporal correlation, semantic matching, or causal dependency analysis.

In some embodiments, the causing presentation, at the user device, includes causing presentation of the indication of the specific condition, the indication of the one or more predefined categories, and the indication of the respective data processing stage.

In some embodiments, the one or more processors are further to: train or prompt the language model by processing a plurality of example input-output pairs, each input-output pair comprising a respective feedback signal as an input and a corresponding predefined category as an output.

In some embodiments the one or more predefined categories include at least one of Incorrect Rephrasing, Irrelevance, Incorrect Re-Ranking, Incorrect or Irrelevant Citations, or Latency.

In some embodiments, the system includes at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for implemented using one or more large language models (LLMs); a system for implemented using one or more vision language models (VLMs); a system implemented using one or more multi-modal language models (MMLMs); a system implemented using one or more inference microservices including one or more open-source level virtualization containers and one or more machine learning models; a system incorporating one or more virtual machines (VMs); a system implemented at least partially in a data center; or a system implemented at least partially using cloud computing resources.

In an embodiments, a method comprises: monitoring a plurality of data processing pipeline stages for a feedback signal; based at least on the monitoring, detecting the feedback signal, the feedback signal indicating an issue affecting at least one of a quality, relevance, or performance of at least one data processing pipeline stage of the plurality of data processing pipeline stages; processing the feedback signal using a machine learning model to classify the feedback signal into one or more predefined categories, each predefined category corresponds to an issue type; mapping the one or more predefined categories to one or more data processing pipeline stages of the plurality of processing pipeline stages; and based at least on the classification and the mapping, triggering a response comprising at least one of generating a diagnostic report, updating a pipeline configuration parameter, or causing presentation of an indication of the predefined category and the one or more data processing pipeline stages at a user interface.

In some embodiments, the feedback signal represents at least one of explicit user feedback, an implicit user behavior signal, or a system-generated performance metric, the system-generated performance metric comprising at least one of a model confidence score, retrieval ranking score, or latency measurement.

In some embodiments, the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for implemented using one or more large language models (LLMs); a system for implemented using one or more vision language models (VLMs); a system implemented using one or more multi-modal language models (MMLMs); a system implemented using one or more inference microservices including one or more open-source level virtualization containers and one or more machine learning models; a system incorporating one or more virtual machines (VMs); a system implemented at least partially in a data center; or a system implemented at least partially using cloud computing resources.

1-9. (canceled)

10. A system comprising one or more processors to:
generate, based at least on a machine learning model processing an indication of a feedback signal, an output comprising a classification of the feedback signal into one or more predefined categories, each predefined category corresponding to at least one of a failure type, an anomaly type, or an inefficiency type;
responsive to the generating of the output comprising the classification of the feedback signal, detect at least a specific condition associated with the failure type, anomaly type, or inefficiency type by analyzing at least one of application logs or application traces;
based at least on the detecting of the specific condition and the classification of the feedback signal, attribute the one or more predefined categories to a respective data processing stage, of a plurality of data processing pipeline stages; and
based at least in part on the attributing of the one or more predefined categories to the respective data processing stage, causing presentation, at a user device, of a at least one of, an indication of the specific condition, an indication of the one or more predefined categories, or an indication of the respective data processing stage.

11. The system of claim 10, wherein the feedback signal represents at least one of explicit user feedback, an implicit user behavior signal, or a system-generated performance metric, the system-generated performance metric comprising at least one of a model confidence score, retrieval ranking score, or latency measurement.

12. The system of claim 10, wherein generating the output further comprises generating a confidence score associated with the classification, the confidence score representing a likelihood that the feedback signal corresponds to a respective predefined category.

13. The system of claim 10, wherein the one or more processors are further to:
responsive to a user query being processed through at least one data processing pipeline stage, causing at least one of the application logs or the application traces to record associated data; and
responsive to the language model generating the output comprising the classification of the feedback signal, detect at least the specific condition that led to an issue using one or more correlation techniques on at least a portion of the application logs or application traces, the one or more correlation techniques comprising temporal correlation, semantic matching, or causal dependency analysis.

14. The system of claim 10, wherein the causing presentation, at the user device,
includes causing presentation of the indication of the specific condition, the indication of the one or more predefined categories, and the indication of the respective data processing stage.

15. The system of claim 10, wherein the one or more processors are further to:
train or prompt the language model by processing a plurality of example input-output pairs, each input-output pair comprising a respective feedback signal as an input and a corresponding predefined category as an output.

16. The system of claim 10, wherein the one or more predefined categories include at least one of Incorrect Rephrasing, Irrelevance, Incorrect Re-Ranking, Incorrect or Irrelevant Citations, or Latency.

17. The system of claim 10, wherein the system includes at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AIoperations;
a system for generating synthetic data;
a system for implemented using one or more large language models (LLMs);
a system for implemented using one or more vision language models (VLMs);
a system implemented using one or more multi-modal language models (MMLMs);
a system implemented using one or more inference microservices including one or more open-source level virtualization containers and one or more machine learning models;
a system incorporating one or more virtual machines (VMs);
a system implemented at least partially in a data center; or
a system implemented at least partially using cloud computing resources.

18-20. (canceled)

21. One or more processors comprising processing circuitry to:
generate, based at least on a machine learning model processing an indication of a feedback signal, an output comprising a classification of the feedback signal into one or more predefined categories, each predefined category corresponding to at least one of a failure type, an anomaly type, or an inefficiency type;
responsive to the generating of the output comprising the classification of the feedback signal, detect at least a specific condition associated with the failure type, anomaly type, or inefficiency type by analyzing at least one of application logs or application traces;
based at least on the detecting of the specific condition and the classification of the feedback signal, attribute the one or more predefined categories to a respective data processing stage, of a plurality of data processing pipeline stages; and
based at least in part on the attributing of the one or more predefined categories to the respective data processing stage, causing presentation, at a user device, of a at least one of, an indication of the specific condition, an indication of the one or more predefined categories, or an indication of the respective data processing stage.

22. The one or more processors of claim 21, wherein the feedback signal represents at least one of explicit user feedback, an implicit user behavior signal, or a system-generated performance metric, the system-generated performance metric comprising at least one of a model confidence score, retrieval ranking score, or latency measurement.

23. The one or more processors of claim 21, wherein generating the output further comprises generating a confidence score associated with the classification, the confidence score representing a likelihood that the feedback signal corresponds to a respective predefined category.

24. The one or more processors of claim 21, wherein the processing circuitry is further to:
responsive to a user query being processed through at least one data processing pipeline stage, causing at least one of the application logs or the application traces to record associated data; and
responsive to the language model generating the output comprising the classification of the feedback signal, detect at least the specific condition that led to an issue using one or more correlation techniques on at least a portion of the application logs or application traces, the one or more correlation techniques comprising temporal correlation, semantic matching, or causal dependency analysis.

25. The one or more processors of claim 21, wherein the causing presentation, at the user device,
includes causing presentation of the indication of the specific condition, the indication of the one or more predefined categories, and the indication of the respective data processing stage.

26. The one or more processors of claim 21, wherein the processing circuitry is further to:
train or prompt the language model by processing a plurality of example input-output pairs, each input-output pair comprising a respective feedback signal as an input and a corresponding predefined category as an output.

27. The one or more processors of claim 21, wherein the one or more predefined categories include at least one of Incorrect Rephrasing, Irrelevance, Incorrect Re-Ranking, Incorrect or Irrelevant Citations, or Latency.

28. A method comprising:
generating, based at least on a machine learning model processing an indication of a feedback signal, an output comprising a classification of the feedback signal into one or more predefined categories, each predefined category corresponding to at least one of a failure type, an anomaly type, or an inefficiency type;
responsive to the generating of the output comprising the classification of the feedback signal, detecting at least a specific condition associated with the failure type, anomaly type, or inefficiency type by analyzing at least one of application logs or application traces;
based at least on the detecting of the specific condition and the classification of the feedback signal, attributing the one or more predefined categories to a respective data processing stage, of a plurality of data processing pipeline stages; and
based at least in part on the attributing of the one or more predefined categories to the respective data processing stage, causing presentation, at a user device, of a at least one of, an indication of the specific condition, an indication of the one or more predefined categories, or an indication of the respective data processing stage.

29. The method of claim 28, wherein the feedback signal represents at least one of explicit user feedback, an implicit user behavior signal, or a system-generated performance metric, the system-generated performance metric comprising at least one of a model confidence score, retrieval ranking score, or latency measurement.

30. The method of claim 28, wherein generating the output further comprises generating a confidence score associated with the classification, the confidence score representing a likelihood that the feedback signal corresponds to a respective predefined category.

31. The method of claim 28, further comprising:
responsive to a user query being processed through at least one data processing pipeline stage, causing at least one of the application logs or the application traces to record associated data; and
responsive to the language model generating the output comprising the classification of the feedback signal, detecting at least the specific condition that led to an issue using one or more correlation techniques on at least a portion of the application logs or application traces, the one or more correlation techniques comprising temporal correlation, semantic matching, or causal dependency analysis.

32. The method of claim 28, wherein the causing presentation, at the user device includes causing presentation of the indication of the specific condition, the indication of the one or more predefined categories, and the indication of the respective data processing stage.
